(19) United States
(12) Patent Application Publication
(10) Pub. No.: US 2014/0310172 A1
(43) Pub. Date: Oct. 16, 2014

(54) CERTIFIED PERSON-TO-PERSON PAYMENT SYSTEM

(71) Applicant: BANK OF AMERICA CORPORATION, Charlotte, NC (US)

(72) Inventors: Glenn M. Grossman, Matthews, NC (US); Peter John Bertanzetti, Charlotte, NC (US); Ed Hagen, Cornelius, NC (US)

(73) Assignee: BANK OF AMERICA CORPORATION, Charlotte, NC (US)

(21) Appl. No.: 13/862,076

(22) Filed: Apr. 12, 2013

(51) Int. Cl. G06Q 20/42; G06Q 20/26

(52) U.S. Cl. CPC G06Q 20/42; G06Q 20/26
USPC 705/44

(57) ABSTRACT

Disclosed is a system for providing certified person-to-person payments. The system is typically configured to (i) receive payment instructions from a payer, wherein the payment instructions include a payment account, a payment amount, an alias associated with a payee, and a payment certification request; (ii) determine that the payment account has funds sufficient to cover the payment amount; (iii) place a hold on funds in the payment account sufficient to cover the payment amount; (iv) receive a payment cancelation request from the payer; (v) determine whether a payment certification code has been communicated to the payer; and (vi), if a payment certification code has not been communicated to the payer, approve the payment cancelation request.

### FIELD OF THE INVENTION

The present invention embraces a system for providing certified person-to-person payments.

### BACKGROUND

With the wide adoption of credits cards, debit cards, electronic payment devices, online shopping systems, and online banking systems, very few people today carry a lot of cash or write many checks. However, people still need to transfer money to each other for all sorts of reasons. For example, a person may want to pay a friend back for money recently borrowed from the friend, or a person may want to send money to a relative as a gift. Giving or lending money to another person, however, can be difficult when you don't have cash on hand and/or if the person is not physically present. The process may need to involve going to an automated teller machine (ATM) or mailing the person a check, both of which can be time consuming and inconvenient depending on the situation.

Money can be transferred from one person to another using electronic banking systems, but these systems traditionally require that the sender know account information for the receiver in order to instruct the bank to transfer money to the proper account. Most people do not know the account numbers of their friends, nor do most people want to widely publicize their account numbers for security reasons.

Some third party service providers try to facilitate payments from one person to another, but many people do not like these systems because they require opening yet another account with another online entity, remembering yet another username and password, and disclosing confidential financial institution account information to these other companies. In addition to the inconvenience and the security concerns, these systems generally take time set up and are not user-friendly.

For all these reasons and others, there is a need for improved user-friendly systems and methods for transferring money between two people and/or other entities, especially if such systems can transfer money directly to and/or from financial institution accounts, such as demand deposit accounts (e.g., checking accounts), and savings accounts.

### SUMMARY

Embodiments of the present invention address these and/or other needs by providing a person-to-person (P2P) payment system along with a user-friendly interface and process for sending and receiving P2P payments. P2P payment systems are disclosed in commonly assigned U.S. Patent Application Publication Nos. 2012/0116967 and 2012/0116957, each of which is hereby incorporated by reference in its entirety. Advantageously, embodiments of the invention do not necessarily require users to share confidential account information with others in order to send and receive payments. In fact, embodiments of the invention do not require that the payment sender know any information about the financial accounts of the intended payment recipient. Furthermore, embodiments of the invention enable users to attempt to make payments to persons that are not customers of the same financial institution and to persons that are not customers of any financial institution.

More specifically, embodiments of the invention allow an entity to transfer certified funds to another entity using a mobile telephone number, electronic mail (email) address, and/or other alias of the transfer recipient. By engaging in a transfer of certified funds, the payee can be confident that the payer has funds sufficient to cover the transaction. Accordingly, there is less risk to the payee that the transfer will later be canceled, disputed, or reversed.

Accordingly, in one aspect the present invention embraces a system for providing certified payments that includes a computer apparatus including a processor and a memory. A certified payment system module is stored in the memory and is executable by the processor. The certified payment system module is typically configured to receive payment instructions from a payer computing device (e.g., a mobile device). As used herein, the term “payer computing device” is intended to include the computing device of an intermediary (e.g., a financial institution) that the payer is using to transmit the payment instructions to the certified payments system. The payment instructions typically include a payment account, a payment amount, an alias associated with a payee, and a payment certification request. After receiving the payment instructions, the certified payment system module is typically configured to determine that the payee is a registered payee based on the alias and determine that the payment account has funds sufficient to cover the payment amount. If the payment account has sufficient funds, the certified payment system module places a hold on funds in the payment account sufficient to cover the payment amount. The certified payment system module is configured to communicate a payment certification code to the payer based upon determining that the payment account has funds sufficient to cover the payment amount. In addition, the certified payment system module is configured to communicate a certified payment notification to the payee based up determining that the payment account has funds sufficient to cover the payment amount and determining that the payee is a registered payee based on the alias. The payment certification code may be provided by the payer to the payee once the payer is ready to complete the transaction. Accordingly, the certified payment system module is configured to receive the payment certification code from the payee (e.g., from a payee computing device). As used herein, the term “payee computing device” is intended to include the computing device of an intermediary (e.g., a financial institution) that the payee is using to transmit the payment certification code to the certified payments system. Thereafter, the certified payment system module transfers funds sufficient to cover the payment to an account associated with the payee based upon receiving the payment certification code from the payee.

In another aspect, the present invention embraces a method a system for providing certified payments that allows a payer to cancel a pending transaction. The system includes a computer apparatus including a processor and a memory. A certified payment system module is stored in the memory and is executable by the processor. The certified payment system module is typically configured to receive payment instructions from a payer computing device (e.g., a mobile device). The payment instructions typically include a payment account, a payment amount, an alias associated with a payee, and a payment certification request. After receiving the payment instructions, the certified payment system module is typically configured to determine that the payee is a registered payee based on the alias and determine that the payment account has funds sufficient to cover the payment amount. If the payment account has sufficient funds, the certified payment system module places a hold on funds in the payment account sufficient to cover the payment amount. In addition, the certified payment system module communicates a certified payment notification to the payee based up determining that the payment account has funds sufficient to cover the payment amount and determining that the payee is a registered payee based on the alias. The certified payment system module is configured to receive a payment cancelation request from the payer and determine whether a payment certification code has been communicated to the payer. If a payment certification code has not been communicated to the payer, the certified payment system module is configured to approve the cancelation request. Thereafter, the certified payment system module is typically configured to, based upon approving the payment cancelation request, remove the hold on the funds sufficient to cover the payment amount, communicate a payment cancelation notification to the payer, and communicate a payment cancelation notification to the payee. If a payment certification code has not been communicated to the payer, the certified payment system module is typically configured to deny the cancelation request and communicate a cancelation request denial notification to the first user. Thereafter, the certified payment system module is typically configured to receive the payment certification code from a payee computing device and transfer the funds sufficient to cover the payment to an account associated with the payee based upon receiving the payment certification code from the payee computing device.

As described in greater detail below, a user interface can be incorporated into the mobile or online banking website of a bank or other financial institution. A user can authenticate her identity using the mobile or online banking authentication system and the user's authentication information and procedures that are already known to the user for interacting with mobile or online banking. The user can then use the mobile or online banking interface to register a mobile phone number, email address, or other alias by associating the number, address, or other alias with one of the user's financial institution accounts. This association is then stored in a data repository that can later be accessed by the bank and, in some cases, other financial institutions. Some embodiments of the invention provide a system for verifying that the alias is owned, held, or otherwise associated with the user, the system including immediately sending a code to the user's device using the alias (e.g., sending a code in a text or email) and having the user enter the code into the mobile or online banking interface shortly thereafter.

The mobile or online banking interface can also be used to initiate transfers to others using aliases. In some embodiments of the invention, a user can create a transfer recipient by entering the recipient's name, alias (e.g., mobile phone number or email address), and a descriptive name for the person, commonly referred to herein as a nickname. The user can then create a transfer request by using the mobile or online banking interface to select an account associated with the user's mobile or online banking account, enter or select the nickname of the saved recipient, and enter a monetary amount. The banking system then accesses the data repository to determine whether the alias is registered and thereby associated with a financial institution account. If the alias is registered, the banking system sends a transfer notification to the recipient using the alias. If the alias is not registered, then the banking system uses the alias to send the transfer recipient a notification (e.g., a text message, email address or the like), the notification telling the person that there is a pending transfer that will be processed if the person registers her alias with an existing financial institution account and/or opens a new financial institution account. The notification then provides a link to the mobile or online banking website, a mobile or online banking website, or a mobile or online banking application that allows the person to easily register an existing account or open a new account.

The mobile or online banking interface can also be used to communicate to the user initiating the transfer (e.g., the payer) the payment certification code that indicates that user's account associated with the transfer has sufficient funds. Afterwards, the recipient of the transfer (e.g., the payee) may enter the payment certification code into the mobile or online banking interface. Then, the funds are transferred to an account associated with the recipient.

Embodiments of the invention also provide a user interface that makes it easy for users to monitor their current, future, pending, and past person-to-person (P2P) and/or person-to-merchant (P2M) funds transfers as well as their saved transfer recipient list, alias registrations, incoming transfers, and/or other related information.

It should be appreciated that at least some embodiments of the invention provide a more convenient, user friendly, and secure P2P payment system because it is provided by the user's bank, through the bank's mobile or online banking system with which the user is already familiar. In at least some embodiments, the user may not need to share personal or confidential information, such as account information, with people or businesses outside of the user's bank. The user can feel more secure having P2P payment services handled by their bank and have the convenience of being able to directly send money from and/or receive money into the user's one or more financial institution accounts.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a combination flowchart and block diagram of a system and method for making P2P payments, in accordance with exemplary embodiments of the present invention;

FIG. 2 is a block diagram illustrating the various ways through which a customer may make P2P payments, in accordance with various embodiments of the present invention;

FIG. 3 provides a block diagram illustrating a certified P2P payment system and environment, in accordance with an embodiment of the present invention;

FIG. 4 provides a block diagram illustrating the first user's computing device of FIG. 3, in accordance with an embodiment of the invention;

FIG. 5 provides a block diagram illustrating the second user's computing device of FIG. 3, in accordance with an embodiment of the present invention;

FIG. 6 provides a block diagram illustrating the financial institution's mobile or online banking system of FIG. 3, in accordance with an embodiment of the invention;

FIG. 7 provides a block diagram illustrating the alias data repository of FIG. 3, in accordance with an embodiment of the present invention;

FIGS. 8A-8E provide flow charts illustrating a process for sending certified P2P payments, in accordance with embodiments of the present invention;

FIGS. 9A-9C provide flow charts for receiving certified P2P payments, in accordance with embodiments of the present invention;

FIG. 10 provides a flowchart for sending certified P2P payments via text message, in accordance with an embodiment of the present invention; and

FIG. 11 provides a flowchart illustrating a process for canceling a certified P2P payment, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

Embodiments of the present invention provide a system and method for certified person-to-person (P2P) payments. Embodiments of the invention allow customers of a financial entity to make payments directly from their accounts, whether their accounts be checking, savings, and/or other accounts, to a payment or transfer recipient (e.g., a payee), including financial entity customers and non-financial entity customers, without having to share any confidential account information and without having to know account information for the intended payment recipient. Embodiments of the invention also allow customers and non-customers to receive payments from others directly into their financial institution accounts without requiring the customer to share account information with the payment sender. It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. Embodiments of the present invention permit a sender to send money from the sender's financial institution account directly to the recipient's financial institution account using the alias of the recipient without the involvement of an intermediary or a third party. This allows for greater security as no party apart from the sender, the recipient, and the bank is ever a part of the transfer. That said, it within the scope of the present invention for the sender to involve an intermediary (e.g., a financial institution) to initiate a transaction or payment or to otherwise interact with a system as described herein. For example, it is within the scope of the present invention for the sender to go to a branch location of a financial institution in order to initiate a certified transaction. Embodiments of the present invention further allow for the certified transfers of funds, which provides the transfer recipient with confidence that the sender (e.g., payer) has sufficient funds to cover the amount of the transfer.

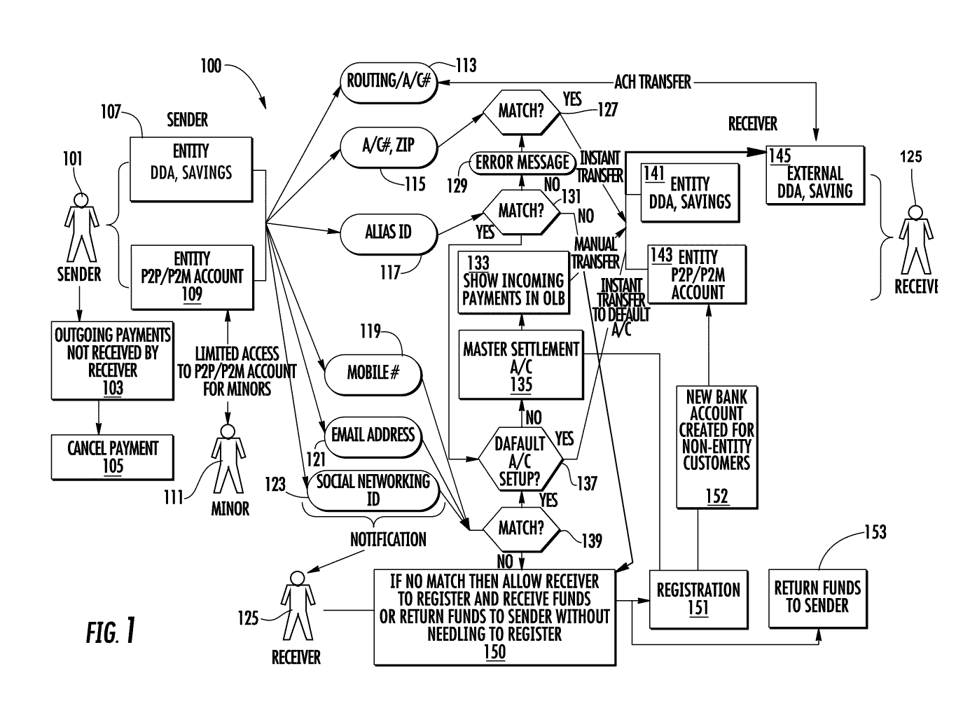

FIG. 1 is a combination block diagram and flowchart providing an overview of a system and method 100 for making P2P payments, in accordance with one or more embodiments of the invention. A customer 101 with an eligible account 107 (e.g., checking (demand deposit account or “DDA”) or savings account) of a financial entity is be able to register and make use of this service. During the registration process, the customer 101 is able to set up an alias identifier (ID) 117 (or simply an “alias”) that maps back to the customer's financial institution account. The alias 117 may be any unique identifier other than the customer's account number. Typically, the alias 117 is an identifier that friends, family, and/or other members of the public uniquely associate with the customer 101. For example, the alias 117 may be a mobile telephone number 119, an email address 121, a social networking ID 123, and/or the like. The embodiments of the invention described herein in the other figures generally permit the customer 101 to use either a mobile telephone number 119 or an email address 121 as the account alias, but it will be appreciated that, in view of this disclosure, other embodiments of the invention may allow use of other types of aliases.

The information provided by the customer 101 during registration of an alias may be verified to confirm that the customer 101 does have access to the mobile number 119, email address 121, social networking ID 123, or other alias 117 provided. For example, as described in greater detail below, the financial institution (or other entity that maintains a database of aliases and associates them with financial institution accounts) may send a communication to the customer 101 using the alias and require the customer 101 confirm access to the alias by responding to the notice in some way. For example, if the alias registered by the customer 101 is a mobile telephone number 119, the financial institution may send a text message to the mobile telephone number 119 with a code and then require that the customer 101 enter the code into a mobile banking or online banking application to confirm that the mobile telephone number is associated with the customer 101. Once the alias information is verified, then the alias is linked to one or more of the customer's financial institution accounts in a data repository maintained by the financial institution or some other entity that provides an alias registry service to the financial institution.

The customer 101 can also use embodiments of the invention to make payments to other entities, such as receiver 125, using an alias of the receiver 125. In some embodiments of the invention, the customer 101 is able to set preferences for accounts to be used for outgoing payments, and default account(s) for incoming payments. In some embodiments of the invention, the financial institution places parameters (e.g., maximums and/or minimums) on how much money can be sent or received using P2P payment aliases, and such parameters may be based on the sender, the receiver, whether the receiver is a customer of the financial institution or a partner financial institution, account history, credit ratings, customer status, whether the customer has registered the alias, and/or any other relevant information. In some embodiments, the customer 101 can also establish parameters on P2P payments. For example, a customer 101 may want to set a maximum of $1000 for P2P payments where an alias is used for the recipient as opposed to an account number.

In some embodiments of the invention, the customer 101 may also have an option of opening a new P2P account 109 with the financial institution that the customer may use exclusively for making and/or receiving P2P payments. This financial entity P2P account 109 may be like any other account hosted at the financial entity and so money may be moved instantly into this account 109 through the regular banking transfer process for moving money between a customer's accounts. This account 109 may be a type of checking account except that it may come with certain limitations (e.g., no checks, maximum balance parameters, number of daily transactions or the like) and may be opened by customers by providing much less information as compared to a regular checking account. The financial entity may, at a minimum, require customers to provide certain information, such as name, address, date of birth, and social security number, in order to comply with Anti-Money Laundering (AML) regulations. Customers 101 of the financial entity may also have an option to set up P2P accounts 109 (e.g., sub-accounts) for minors 111, other dependents, or related entities. Customers 101 are able to access these accounts just like any of their other accounts. In addition, customers 101 are able to set up a banking access ID for the minor 111 that the minor 111 may use to sign into mobile or online banking but have access only to the specific minor P2P account 109 set up for them. These P2P-specific accounts and sub-accounts are described in more detail in commonly assigned U.S. Pat. No. 8,249,985, which is hereby incorporated by reference in its entirety.

Referring again to FIG. 1, customers 101 of the financial entity are able to make payments to other people through any of a number of different methods. Payments may be made by a routing number/account number 113. Payments may also be made by providing an account number and an additional identifier, such as a zip code 115. If there is a match to an existing financial entity account in step 127, then the funds can be transferred to that account. Else, an error message 129 may be generated.

In accordance with embodiments of the invention, payments may be made by providing an alias 117. In general, as described in greater detail below, the customer 101 initiates a P2P payment using an alias by communicating an alias 117 and an associated payment amount to the financial institution. The financial institution then accesses an alias database, or other type of data repository, to determine if the entered alias 117 has been registered by the alias holder and is, thereby, associated with a particular financial institution account. If the alias 117 does have a match to another customer in step 131 or financial institution account of another customer 131, then the payment may be initiated to that person, as described in greater detail below. In some embodiments, once a match has been found for the alias 117, the financial institution determines that the payment account has funds sufficient to cover the payment amount. If the payment account has sufficient funds, the financial institution places a hold on funds in the payment account sufficient to cover the payment amount. For example, the financial institution may transfer sufficient funds from the payment account to the financial institution's general ledger. In addition, the financial institution provides a payment certification code (e.g., an alphanumeric code or a barcode) to the payer if the payment account has funds sufficient to cover the payment amount. The payment certification code is typically unique to the particular transfer. The payment certification code is typically provided by the payer to the payee once the payer is ready to complete the transaction. If the payment account does not have sufficient funds, the financial institution typically will not issue a payment certification code. Once the payee has the payment certification code, the payee provides the payment certification code to the financial institution, after which the financial institution transfers the held funds (e.g., from the financial institution's general ledger) to an account associated with the payee. Until the payee provides the payment certification code, the financial institution will typically continue to hold the funds and refrain from transferring the funds to the payee.

If there is no match, then either an error message 129 is generated or, if possible, the alias 117 may be used to contact the intended recipient 125 and allow this person to register the alias 117 and thereby associate the alias with a financial institution account. At any time, if outgoing payments or payment notifications are not received by a receiver (as represented by block 103), the payment may be canceled (as represented by block 105).

In some embodiments of the invention, an alias 117 may be associated with multiple financial institution accounts of the alias holder. In some such embodiments, the alias holder may be able to establish a default account when registering the alias 117 or afterwards. Consequently, if a receiver 125 does have a default account for incoming payments in 137, then the funds may be transferred to that account(s). If the receiver 125 has not set up a default account in 137 but the receiver 125 does have multiple accounts associated with the alias 117, then the funds may be moved to a master settlement account 135 and the receiver 125 may see the payment as an incoming payment within mobile or online banking 133. The receiver 125 may then be able to use the banking application to move the funds to any of the receiver's others accounts. In other embodiments, however, each alias 117 is associated only with one financial institution account and, therefore, steps 137 and 135 are not needed and the payment is deposited directly into the one financial institution account associated with the alias 117.

As further illustrated in FIG. 1, the alias 117 may be a mobile telephone number 119 and, as such, payment may be made by the customer 101 providing a mobile phone number 119 (the mobile telephone number 119 being the mobile telephone number of the intended payment recipient 125) along with an associated payment amount. This operation may perform exactly as described above for the alias 117 if there is a match in 139 on the mobile number. If there is no match in 139, then a text message may be sent to the mobile number 119 provided (as represented by block 150). If the receiver 125 of the message is an existing financial institution customer (or, in some embodiments, if the receiver 125 is a customer of a partner financial institution), then that person may be allowed to sign into their online or mobile banking account, register the phone number as illustrated by block 151 (thereby associating the phone number with a financial institution account for P2P payment purposes), and then receive funds similar to the process described above for the alias 117. If the receiver 125 is not a financial entity customer with an account eligible for receiving funds, then the receiver 125 may be given the option to sign up (as represented by block 152) for a financial institution account 141 or 143 at the financial institution (or an external account, such as a DDA or savings account at a different institution 145) or return funds to the sender (as represented by block 153).

As further illustrated in FIG. 1, the alias 117 may be an email address 121 and, as such, payment may be made by the customer 101 providing an email address 121 (the email address 121 being an email address of the intended payment recipient 125) along with an associated payment amount. This operation may perform exactly as described above for a mobile number 119 except that the notification message (with the registration or account opening option if appropriate) is sent to the email address 121 provided.

In some embodiments of the invention, payment may be made by providing a social networking ID 123, such as a unique ID associated with the receiver 125 on a particular social networking Internet site. In such a situation, the process operates in the same way as described above for mobile phone number 119 and email address 121 except the social networking platform may be used to notify the receiver based on the social networking ID 123 provided.

In all cases described above, if the receiver 125 is already a customer of the financial institution or a partner financial institution and has already registered the alias 117 provided by the sender 101, a text message, email, mobile banking notice, online banking notice, or other type of message may be sent to receiver 125 based on the alias 117 entered by the sender 101 or irrespective of information entered by sender if there is other contact information found in the receiver's profile, the notification notifying the receiver 125 of the payment. In some embodiments, the receiver 125 may be allowed to reject or re-route the payment. In some embodiments of the invention, the sender 101 is permitted to include a note to the recipient 125 along with the payment, such as a note explaining to the recipient what the purpose of the payment is for.

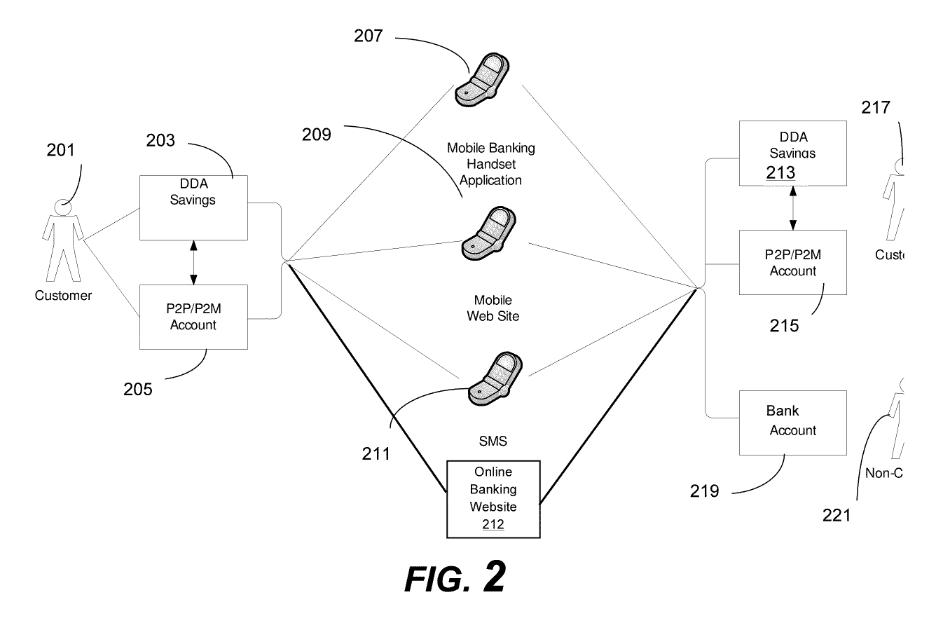

FIG. 2 is a block diagram illustrating the various ways through which a customer may make P2P payments in accordance with various embodiments of the invention. As illustrated, in some embodiments of the invention, a customer 201 who is signed up for the P2P payment service has the option to initiate P2P payments from an account 203 (e.g., from a DDA or a savings account) of the financial entity (and/or from a P2P-specific account 205 with the financial entity) through the financial entity's mobile banking website 209 or a mobile banking handset application 207 by providing any of the above-described alias information (e.g., phone number, email address, social networking ID, and/or other alias) along with a payment amount. In some embodiments of the invention, customers can alternatively or additionally initiate payments by sending a text message 211 to the financial entity, the text message including the receiver's phone number, email address, social networking ID, nickname, or other alias. In some embodiments, customers can alternatively or additionally use the financial institution's online banking website 212 to initiate a payment using an alias, as described in greater detail below. Whether via a mobile banking handset application 207, mobile website 209, short message service 211, or online banking 212, a receiver 217 associated with the financial entity may receive funds at the receiver's financial institution account (e.g., DDA, savings, or credit account 213 or P2P-specific account 215). A receiver 221 not associated with the financial entity 221 may receive funds at the receiver's financial institution account 219 at another partner financial institution if the account is registered and associated with the alias and/or the receiver 221 may be prompted to register for the service and/or open an account with the financial institution in order to receive the payment from the sender 201.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution send payments to anyone outside the financial entity using an alias. In such embodiments, the non-customers are contacted using the alias and they are allowed to quickly open and/or register an account with the financial institution in order to receive the funds from the sender.

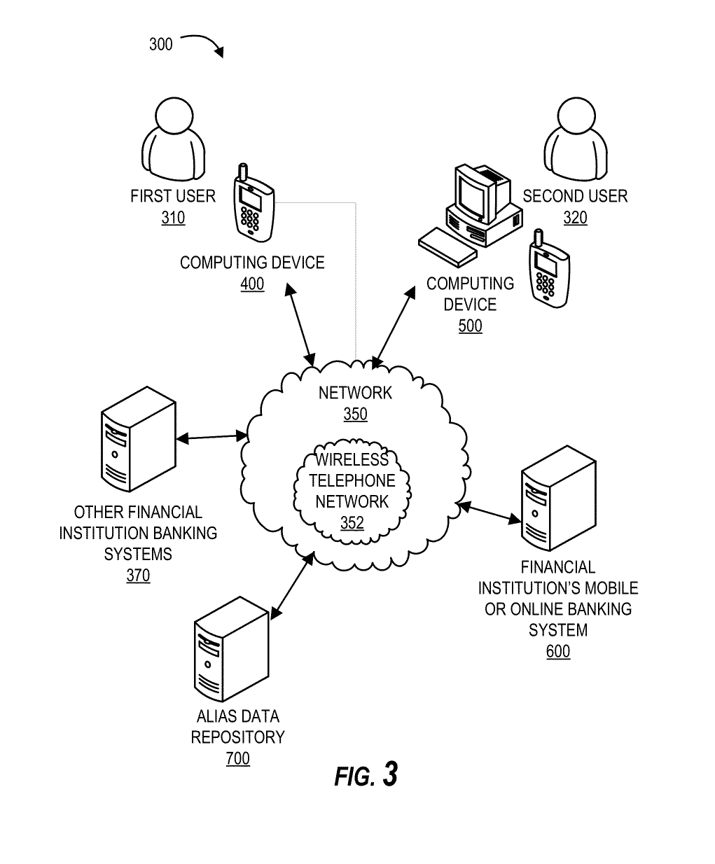

As described above, FIGS. 1 and 2 provide an overview of the alias-type P2P payment system and process of embodiments of the invention. FIGS. 3-10, described below, provide a more detailed description of some systems and methods of implementing embodiments the invention in a mobile or online banking environment. Specifically, embodiments of the invention described below disclose a system and associated method that may be used by a financial institution to: (i) allow customers to send certified P2P payments using an alias of the intended recipient; (ii) allow customers to register a customer's aliases and then receive alias-type certified P2P payments from others; and (iii) allow customers to easily manage their certified P2P payments.

FIG. 3 provides a block diagram illustrating a certified P2P payment system and environment 300, in accordance with an embodiment of the invention. As illustrated in FIG. 3, the P2P payment environment 300 includes a first user 310 and a second user 320 where a first user wants to send funds to a second user. A user of the system may be a person, but may also be a business (e.g., a merchant) or any other entity capable of sending or receiving funds.

The environment 300 also includes a first computing device 400 and a second computing device 500 for the first user 310 and second user 320, respectively. The first and second computing devices may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, a tablet computer, a laptop, or other mobile device.

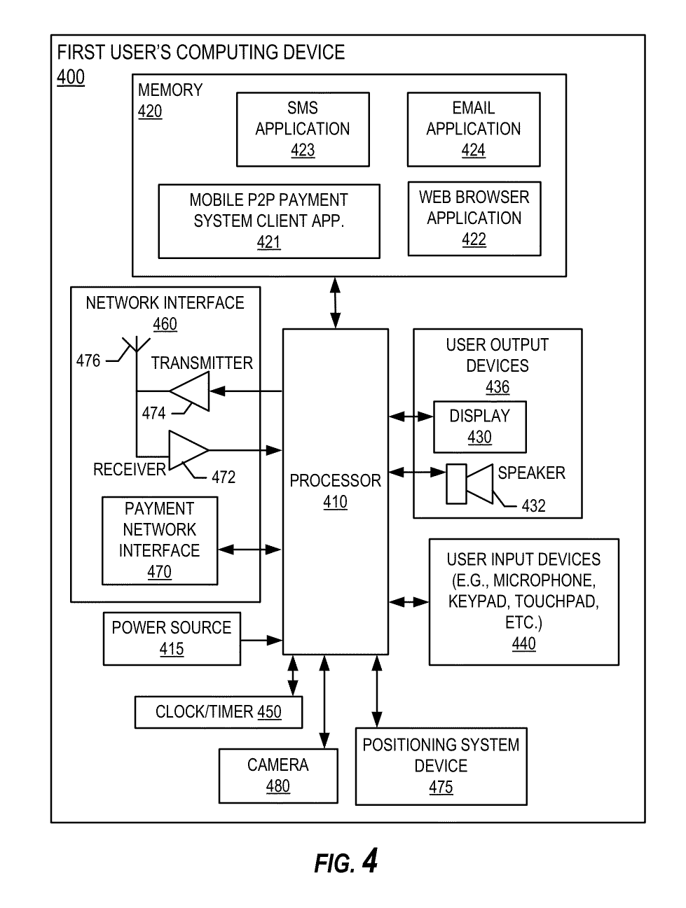

The first computing device 400 and the second computing device 500 are typically configured to communicate over a network 350 with a financial institution's online or mobile banking system 600 and, in some cases, one or more other financial institution banking systems 370. The first computing device 400, the second computing device 500, the financial institution's mobile or online banking system 600, an alias data repository 700, and any other participating financial institution's banking systems 370 are each described in greater detail below with reference to FIGS. 4-7. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone network 352.

In general, a first computing device 400 is configured to connect with the network 350 to log the first user 310 into an online or mobile banking system 600. The online or mobile banking system 600 involves authentication of a first user in order to access the first user's account on the online or mobile banking system 600. For example, the online or mobile banking system 600 is a system where a first user 310 logs into his/her account such that the first user 310 or other entity can access data that is associated with the first user 310. For example, in one embodiment of the invention, the system 600 may be a mobile or online banking system maintained by a financial institution. In such an embodiment, the first user 310 can use the first computing device 400 to log into the mobile or online banking system to access the first user's mobile or online banking account. Logging into the mobile or online banking system 300 generally requires that the first user 310 authenticate his/her identity using a user name, a passcode, a cookie, a biometric identifier, a private key, a token, and/or another authentication mechanism that is provided by the first user 310 to the mobile or online banking system 600 via the first computing device 400.

The financial institution's mobile or online banking system 600 is typically in network communication with other devices, such as other financial institutions' transaction/banking systems 370, an alias data repository 700, and a second computing device 500 that is configured to communicate with the network 350 to log a second user 320 into the mobile or online banking system 600. In one embodiment, the invention may provide an application download server such that software applications that support the mobile or online banking system 600 can be downloaded to the first and second computing devices.

In some embodiments of the invention, the application download server is configured to be controlled and managed by one or more third-party data providers (not shown in FIG. 3) over the network 350. In other embodiments, the application download server is configured to be controlled and managed over the network 350 by the same entity that maintains the mobile or online banking system 600.

In some embodiments of the invention, the alias data repository 700 is configured to be controlled and managed by one or more third-party data providers (not shown) over the network 350. In other embodiments, the alias data repository 700 is configured to be controlled and managed over the network 350 by the same entity that maintains the financial institution's mobile or online banking system 600. In other embodiments, the alias data repository 700 is configured to be controlled and managed over the network 350 by the financial institution implementing the mobile payment system of the present invention. In still other embodiments, the alias data repository 700 is a part of the mobile or online banking system 600.

FIG. 4 provides a block diagram illustrating an exemplary first computing device 400 of FIG. 3 in more detail, in accordance with embodiments of the invention. In particular, FIG. 4 depicts the first computing device 400 as a mobile device 400. In one embodiment of the invention, the mobile device is a mobile telephone. However, it should be understood, however, that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, cameras, video recorders, audio/video player, radio, GPS devices, or any combination of the aforementioned.

The mobile device 400 typically includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, typically include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is typically configured to use the network interface 460 to communicate with one or more other devices on the network 350. In this regard, the network interface 460 typically includes an antenna 476 operatively coupled to a transmitter 474 and a receiver 472 (together a “transceiver”). The processor 410 is typically configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The network interface 460 may also include a payment network interface 470. The payment network interface 470 may include software, such as encryption software, and hardware, such as a modem, for communicating information to and/or from one or more devices on a network 350. For example, the mobile device 400 may be configured so that it can wirelessly communicating account numbers or other authentication information to a terminal of the network 350.

As described above, the mobile device 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400 to receive data from a user such as the first user 310, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a merchant or other location to determine that the consumer mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device 400 described herein. For example, the memory 420 may include such applications as a conventional web browser application 422 and/or a mobile certified P2P payment system client application 421. These applications also typically provide a graphical user interface (GUI) on the display 430 that allows the first user 310 to communicate with the consumer mobile device 400, the mobile or online banking system 600, and/or other devices or systems. In one embodiment of the invention, when the first user 310 decides to enroll in the mobile or online banking program, the first user 310 downloads or otherwise obtains the mobile or online banking system client application from the mobile or online banking system 600 or from a distinct application server. In other embodiments of the invention, the first user 310 interacts with the mobile or online banking system 600 via the web browser application 422 in addition to, or instead of, the mobile P2P payment system client application 421.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information.

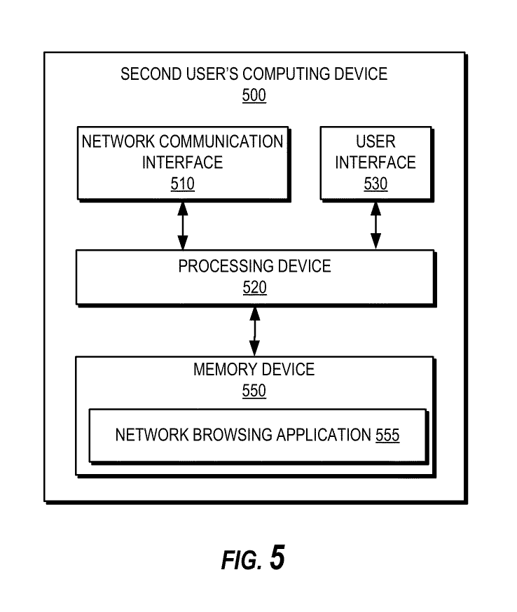

Referring now to FIG. 5, the computing device 500 associated with the second user 320 also includes various features, such as a network communication interface 510, a processing device 520, a user interface 530, and a memory device 550. The network communication interface 510 includes a device that allows the personal computing device 500 to communicate over the network 350 (shown in FIG. 3). In one embodiment of the invention, a network browsing application 555 provides for a user to establish network communication with a mobile or online banking system 600 (shown in FIG. 3) for the purpose of initiating a certified payment and/or registering an account and/or alias with the mobile payment system and/or receiving a certified payment, in accordance with embodiments of the invention.

As used herein, a “processing device,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 530 generally includes a plurality of interface devices and/or software that allow a customer to input commands and data to direct the processing device to execute instructions. For example, the user interface 530 presented in FIG. 5 may include a graphical user interface (GUI) or an interface to input computer-executable instructions that direct the processing device 520 to carry out specific functions. The user interface 530 employs certain input and output devices to input data received from the first user 310 or second user 320 or output data to the first user 310 or second user 320. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 550 generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

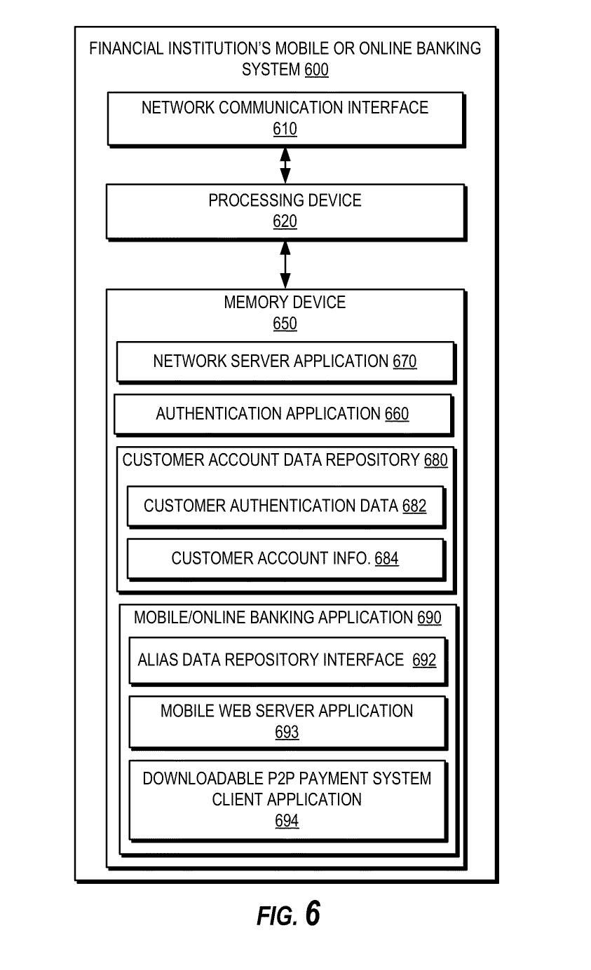

FIG. 6 provides a block diagram illustrating the mobile or online banking system 600 in greater detail, in accordance with an embodiment of the invention. As illustrated in FIG. 6, in one embodiment of the invention, the mobile or online banking system 600 includes a processing device 620 operatively coupled to a network communication interface 610 and a memory device 650. In certain embodiments, the mobile or online banking system 600 is operated by a first entity, such as a financial institution, while in other embodiments, the mobile or online banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the mobile or online banking system 600 described herein. For example, in one embodiment of the mobile or online banking system 600, the memory device 650 includes, but is not limited to, a network server application 670, an authentication application 660, a customer account data repository 680 which includes customer authentication data 680 and customer account information 684, a mobile or online banking application 690 which includes an alias data repository interface 692, a mobile web server application 693, a downloadable P2P payment system client application 694 and other computer-executable instructions or other data. The computer-executable program code of the network server application 670, the authentication application 660, or the mobile or online banking application 690 may instruct the processing device 620 to perform certain logic, data-processing, and data-storing functions of the mobile or online banking system 600 described herein, as well as communication functions of the mobile or online banking system 600.

In one embodiment, the customer account data repository 680 includes customer authentication data 682 and customer account information 684. The network server application 670, the authentication application 660, and the mobile or online banking application 690 are configured to implement customer account information 684, the customer authentication data 682, and the alias data repository interface 692 when authenticating the customer 101 (or the first user 310) to the mobile or online banking system 600. The customer account information 684, the customer authentication data 682, and the alias data repository interface 692 are discussed in more detail in a later section.

As used herein, a “communication interface” typically includes a modem, server, transceiver, and/or other device for communicating with other devices on a network, and/or a user interface for communicating with one or more customers. Referring again to FIG. 6, the network communication interface 610 is a communication interface having one or more communication devices configured to communicate with one or more other devices on the network 350, such as the first computing device 400 (e.g., a mobile device 400), the second computing device 500, the mobile or online banking system 600, the other financial institution banking systems 370, and the alias data repository 700. The processing device 620 is typically configured to use the network communication interface 610 to transmit and/or receive data and/or commands to and/or from the other devices connected to the network 350.

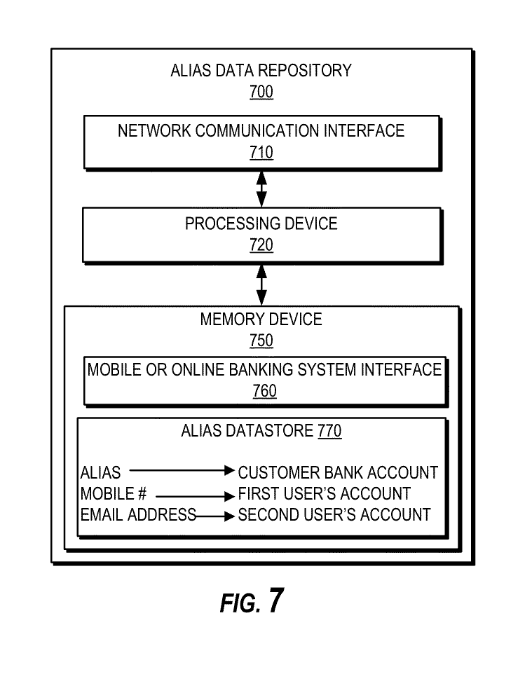

FIG. 7 provides a block diagram illustrating an alias data repository 700, in accordance with an embodiment of the invention. In one embodiment of the invention, the alias data repository 700 is operated by a second entity that is a different or separate entity from the first entity (e.g., the financial institution) that, in one embodiment of the invention, implements the mobile or online banking system 600. In one embodiment, the alias data repository 700 could be part of the mobile or online banking system 600. In another embodiment, the alias data repository 700 is a distinct entity from the mobile or online banking system 600. As illustrated in FIG. 7, the alias data repository 700 generally includes, but is not limited to, a network communication interface 710, a processing device 720, and a memory device 750. The processing device 720 is operatively coupled to the network communication interface 710 and the memory device 750. In one embodiment of the alias data repository 700, the memory device 750 stores, but is not limited to, a mobile or online banking system interface 760 and an alias data store 770. The alias data store 770 stores data including, but not limited to, an alias for the customer's financial institution account, mobile number or email address for the first user's 310 account, and a mobile number and/or email address for the second user's 320 account. In one embodiment of the invention, both the mobile or online banking system interface 760 and the alias data store 770 may associate with applications having computer-executable program code that instructs the processing device 720 to operate the network communication interface 710 to perform certain communication functions involving the alias data store 770 described herein. In one embodiment, the computer-executable program code of an application associated with the alias data store 770 may also instruct the processing device 720 to perform certain logic, data processing, and data storing functions of the application associated with the alias data store 770 described herein. An alias, as defined in this invention, is not limited to just a mobile device number or an email address.

The network communication interface 710 is a communication interface having one or more communication devices configured to communicate with one or more other devices on the network 350. The processing device 720 is configured to use the network communication interface 710 to receive information from and/or provide information and commands to a first computing device 400, a second computing device 500, other financial institution banking systems 370, the alias data repository 700, the mobile or online banking system 600 and/or other devices via the network 350. In some embodiments, the processing device 720 also uses the network communication interface 710 to access other devices on the network 350, such as one or more web servers of one or more third-party data providers. In some embodiments, one or more of the devices described herein may be operated by a second entity so that the third-party controls the various functions involving the alias data repository 700. For example, in one embodiment of the invention, although the mobile or online banking system 600 is operated by a first entity (e.g., a financial institution), a second entity operates the alias data repository 700 that stores the alias details for the customer's financial institution accounts and other information about customers.

As described above, the processing device 720 is configured to use the network communication interface 710 to gather data from the various data sources. The processing device 720 stores the data that it receives in the memory device 750. In this regard, in one embodiment of the invention, the memory device 750 includes datastores that typically include: (i) aliases for customer financial institution account numbers and routing information, (ii) information about sending and receiving users' mobile device numbers, email addresses, or other contact information, which may have been received from the mobile or online banking system 600; (iii) a list of customer IDs or authentication data received from the mobile or online banking system 600; and/or (iv) customer credentials (e.g., a customer ID) received from a customer's computing device or received from the mobile or online banking system 600 in response to the customer accessing the mobile or online banking system 600.

In one embodiment of the invention, an application server is provided to support various supporting systems on the network 350, including the wireless telephone network 352. The application server includes a network communication interface, a processing device, and a memory device. The network communication interface and the processing device are similar to the previously described network communication interface 610 and the processing device 620 previously described. For example, the processing device is operatively coupled to the network communication interface and the memory device. In one embodiment of the application server, the memory device includes a network browsing application having computer-executable program code that instructs the processing device to operate the network communication interface to perform certain communication functions of the application download server described herein.

As discussed above, in one embodiment of the invention, an application download server might be provided. The application download server may include a network communication interface, a processing device, and a memory device. The network communication interface and processing device are similar to the previously described network communication interface 610 and the processing device 620 previously described. For example, the processing device is operatively coupled to the network communication interface and the memory device. In one embodiment of the application download server, the memory device includes a network browsing application having computer-executable program code that instructs the processing device to operate the network communication interface to perform certain communication functions of the application download server described herein. In some embodiments of the invention, the application download server provides applications that are to be downloaded to a qualified customer's mobile device or personal computing device.

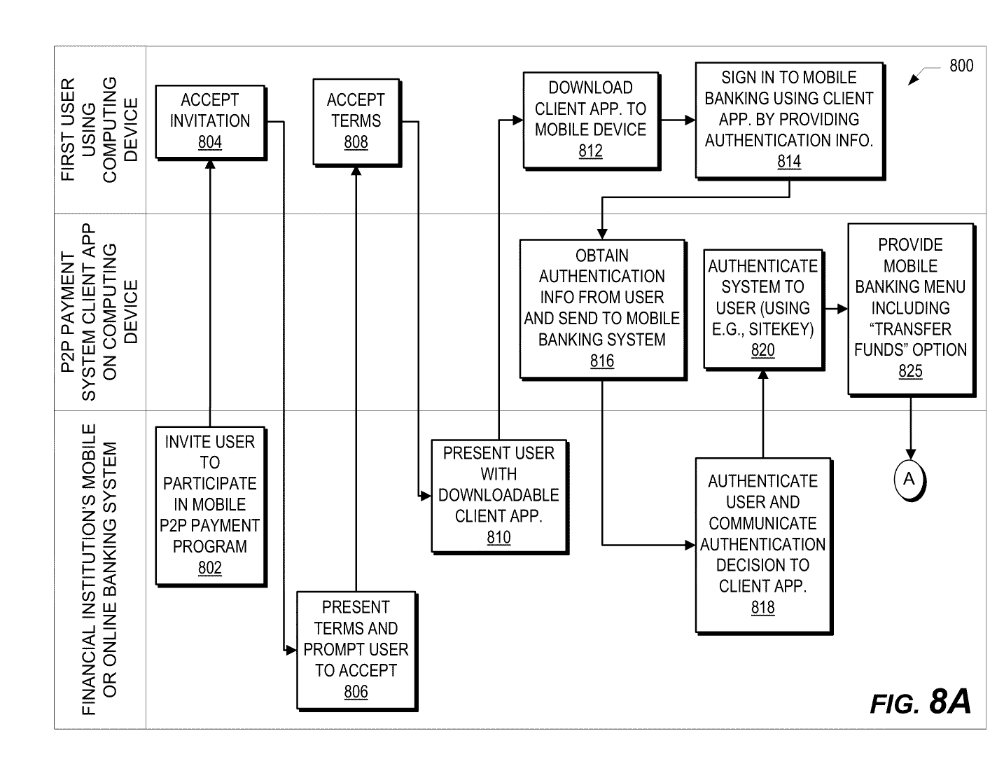

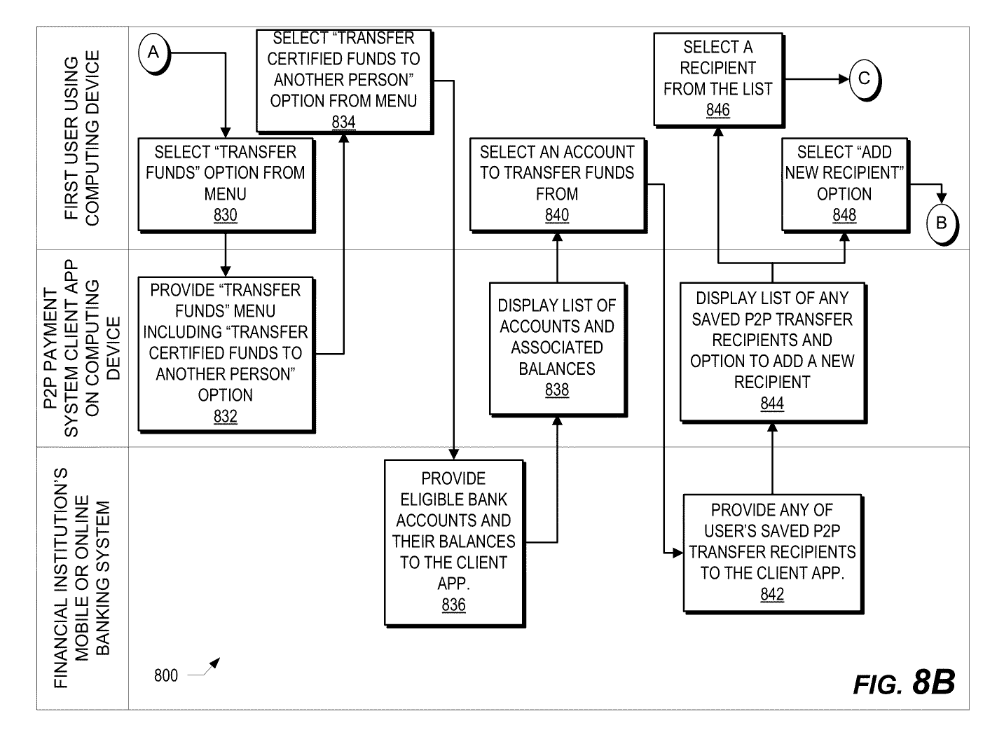

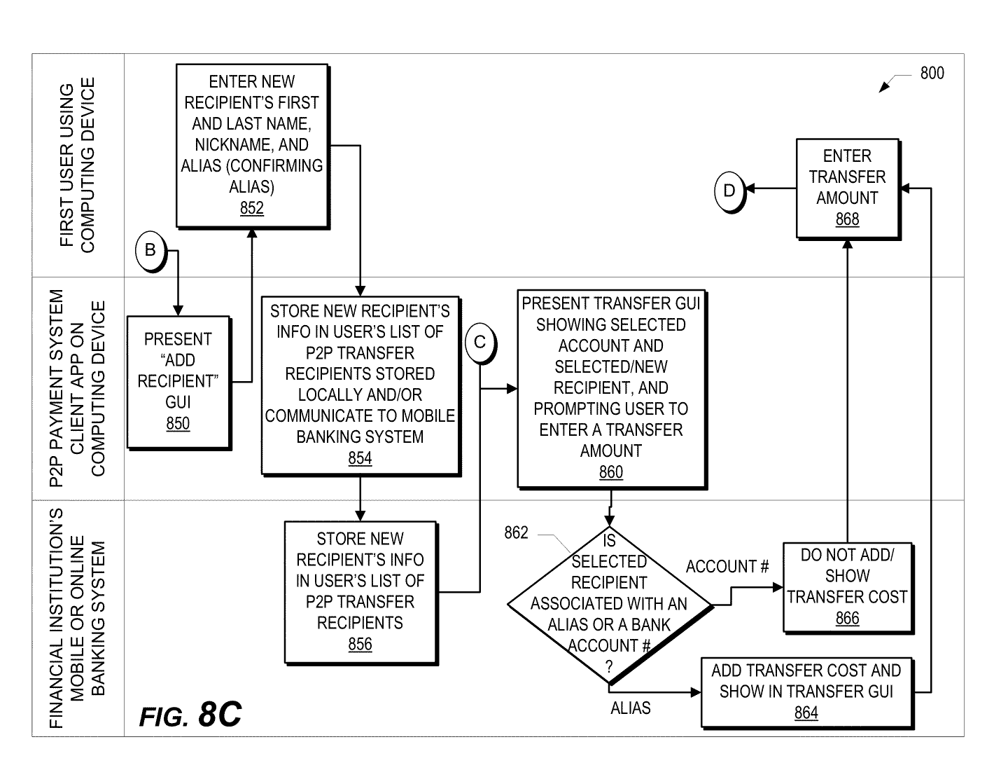

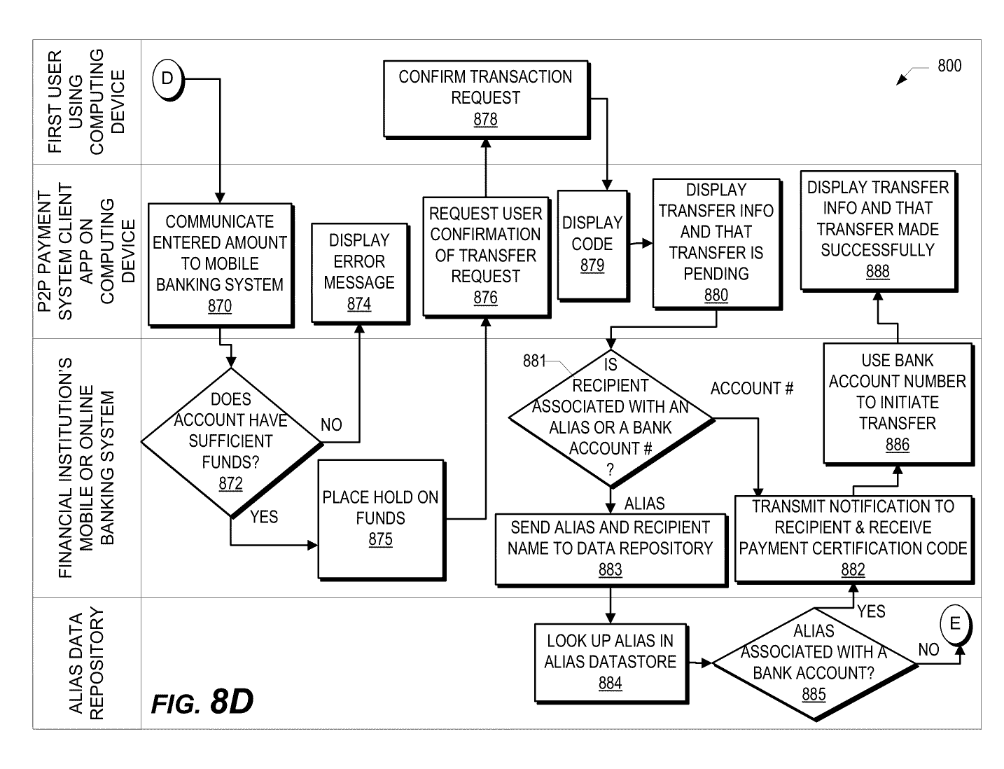

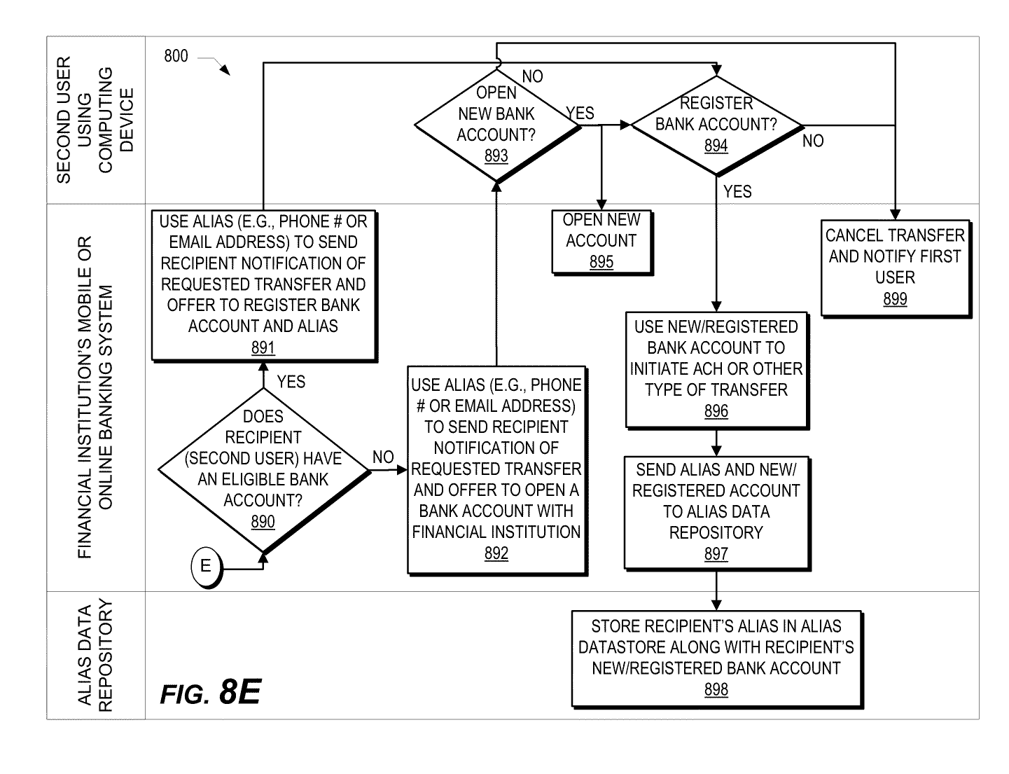

FIGS. 8A-8E provide flow charts illustrating an exemplary process 800 for sending certified P2P payments via alias using a computing device, in accordance with an embodiment of the invention. FIGS. 8A-8E illustrate the flow chart in terms of “swim lanes” associated with entities which may perform the operations in each respective swim lane. The entities illustrated in the exemplary Figures are a financial institution's mobile or online banking system, a first user using a computing device, an alias data repository, and a second user using a second computing device. However, it should be noted that other entities could also be involved and some embodiments of the invention may not be limited to the four entities illustrated in FIGS. 8A-8E. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 802 of FIG. 8A where a financial institution's mobile or online banking system 600 invites a user to participate in a P2P payment program. In one embodiment, the mobile or online banking system 600 only invites certain existing mobile or online banking users who fit certain criteria, including, but not limited to, pre-determined minimum account balance, number of years since the user first opened an account, and the like.

The process then moves to block 804 where the first user 310 using a first computing device 400 (e.g., a mobile device) accepts the invitation.

The process then moves to block 806 of FIG. 8A where the mobile or online banking system 600 presents to the first user the terms of the P2P transfer feature that will govern the transfer of funds. In one embodiment, the first user can read the terms on the first user's computing device 400.

The process then moves to block 808 of FIG. 8A. The first user accepts the terms of the P2P service (e.g., by activating an appropriate button on a mobile webpage).

The process then moves to block 810 of FIG. 8A where the mobile or online banking system 600 presents the first user with a downloadable client application.

The process then moves to block 812 of FIG. 8A where the first user 310 downloads the client application to the first user's computing device 400.

The process then moves to block 814 of FIG. 8A where the first user 310 signs in to the mobile or online banking system 600 using the client application by providing appropriate authentication information. Alternatively, the first user 310 may sign in to the mobile or online banking system 600 using an online website.

The process then moves to block 816 of FIG. 8A where the P2P payment system client application 694 on the first computing device 400 obtains authentication information from the first user and sends the authentication information to the mobile or online banking system 600.

The process then moves to block 818 of FIG. 8A where the mobile or online banking system 600 authenticates the first user 310 and communicates the authentication decision to the P2P payment system client application 694.

The process then moves to block 820 of FIG. 8A where the P2P payment system client application 694 authenticates the system to the first user 310. In one embodiment of the invention, the authentication is achieved using “SiteKey,” which is a web-based security system that provides mutual authentication between end-users and websites. In a challenge-response process of SiteKey, the first user has to identify himself or herself on a secure website by entering a username. Subsequently, the website authenticates itself to the first user by displaying an image and an accompanying phrase that the first user had previously configured. If the user recognizes this image and the accompanying phrase, the first user can authenticate himself or herself to the website by entering a password. Other embodiments of the invention may use other authentication systems.

The process then moves to block 825 of FIG. 8A where the P2P payment system client application 694 provides a mobile or online banking menu including an option to transfer funds. The P2P payment system client application 694 typically displays a bank menu page on which the first user can navigate to an accounts function, a bill-paying function, a transfer funds function, or a location function. Further, the P2P payment system client application 694 indicates to the first user that the first user is in a secure area of the mobile or online banking system 600. The bank menu page also has a text area where error messages are displayed. The P2P payment system client application 694 typically allows users to sign out from their accounts on any mobile webpage by providing an appropriate hyperlink or button.

The process then moves to block 830 of FIG. 8B where the first user 310 selects the transfer funds option (e.g., from a menu).

The process then moves to block 832 of FIG. 8B where the P2P payment system client application 694 provides a transfer funds menu that includes an option to transfer certified funds to another person. For example, the P2P payment system client application 694 may display three options for the first user including an option to transfer between the first user's own accounts, an option to transfer certified funds to another person, and an option to schedule a transfer of certified funds for later execution. In one embodiment, each of these three options are hyperlinks that are linked to mobile or online payment system 600. The P2P payment system client application 694 may indicate to the first user using a static textbox that any transfers made to an account before a cutoff time on any day will be credited to that account; otherwise the transfer will credited on the following business day.

The process then moves to block 834 of FIG. 8B where the first user 310 selects the option to transfer certified funds to another person from the transfer funds menu.

The process then moves to block 836 of FIG. 8B where the mobile or online banking system 600 provides eligible financial institution accounts and their balances to the P2P payment system client application 694.

The process then moves to block 838 of FIG. 8B where the P2P payment system client application 694 displays a list of eligible financial institution accounts that can participate in the P2P transfer as well as their associated balances. The P2P payment system client application 694 also indicates to the first user that the balances may reflect transactions that have not yet been posted to the first user's account.

The process then moves to block 840 of FIG. 8B where the first user 310 can select an account to transfer funds from.

The process then moves to block 842 of FIG. 8B where the mobile or online banking system 600 provides any of first user's saved P2P transfer recipients to the P2P payment system client application 694.

The process then moves to block 844 of FIG. 8B where the P2P payment system client application 694 displays a list of any saved P2P transfer-to accounts or recipients and an option to add a new recipient. Activating any particular transfer-to account that is in the name of or otherwise associated with the first user will take the first user to an account details page for that particular account. Activating any particular transfer-to account not in the name of or associated with by the first user (i.e., another user's account) will not take the first user to an account details page for that particular account. In one embodiment, the first user cannot see the balance of a transfer-to account not in the name of or associated with the first user. In one embodiment, the P2P payment system client application 694 can only display a first pre-determined number of transfer-to accounts or recipients per page. Therefore, if the number of transfer-to accounts are greater than a first pre-determined number, then a first user has to activate the next button to choose other recipients if the user wants to choose a recipient who is not in the initial pre-determined displayed list of recipients. If the number of transfer-to accounts or recipients are greater than a second higher pre-determined number, then the P2P payment system client application 694 provides the first user with the next button and the previous button to navigate between groups of recipients. If the number of transfer-to accounts or recipients is greater than a first pre-determined number but smaller than a second higher pre-determined number, then the P2P payment system client application 694 provides the first user with a previous button but not a next button. In one embodiment of the invention, the first pre-determined number is 10 and the second higher pre-determined number is 20.

The process then moves to block 846 of FIG. 8B where the first user 310 can select a recipient from the list to participate in the P2P transfer by activating the link associated with a particular recipient. If the user selects an existing recipient, then the P2P payment system client application 694 presents to the user the transfer GUI of block 860 (FIG. 8C) that is described later. Alternatively, the process can move to block 848 of FIG. 8B where the first user adds a new recipient by activating the link to add a new recipient. In one embodiment, in which the user is limited to adding a predetermined number of new recipients in a daily period, if the first user has reached the pre-determined daily recipient maximum, the P2P payment system client application 694 displays an error message on an area of a mobile webpage.

The process then moves to block 850 of FIG. 8C where the P2P payment system client application 694 presents to the first user a GUI to add a new recipient. The P2P payment system client application 694 may present an input field to enter the recipient's first name, an input field to enter the recipient's last name, an input field to enter a nickname associated with the recipient as chosen by the first user, a first input field to enter an alias, and a second input field to re-enter the alias which is checked against the alias entered into the first input field to verify that both aliases match. In one embodiment, the alias can be, but is not limited to, a mobile device number or an email address. The GUI also presents the user with a button to add the new recipient. The process then moves to block 852 of FIG. 8C where the first user enters the new recipient's first name, last name, nickname, and alias, along with re-entering the alias and activating the button the add the recipient. A pre-confirmation page may be now displayed where the P2P payment system client application 694 asks the first user to confirm the details of the recipient by activating the confirm button. In one embodiment, the complete set of characters comprising the alias are not displayed on the pre-confirmation page. By activating any of the entries entered by the first user, the first user can be taken back to the mobile webpage for adding recipient details. For instance, if the first user activates the first name that is displayed on the pre-confirmation page, a hyperlink embedded into the text allows the first user to return to the pre-confirmation page for editing the first name.

Once the first user activates the confirm button, the process moves to block 854 of FIG. 8C where the P2P payment system client application 694 locally stores the new recipient's information in the first user's list of P2P transfer recipients and/or communicated to the mobile or online banking system 600.

The process then moves to block 856 of FIG. 8C where the mobile or online banking system 600 stores the new recipient's information in the first user's list of P2P transfer recipients.

The process then moves to block 860 of FIG. 8C where the P2P payment system client application 694 presents a transfer GUI showing selected account and selected/new recipient, and prompting the first user to enter a transfer amount. For example, the mobile P2P payment system client application 694 may display the transfer-from account, the transfer-to account or recipient alias, and an input text box for entering the amount that the first user 310 wishes to transfer. The GUI may also present disclosure text regarding any possible costs that will be incurred by the first user for making this transfer. The GUI may also display a submit button for submitting the transfer and a cancel button for canceling the transfer and returning to the menu page shown.

The process then moves to block 862 of FIG. 8C where the mobile or online banking system 600 determines if the selected recipient is associated with an alias or a financial institution account number.

If, in block 862 of FIG. 8C, the mobile or online banking system 600 determines that the selected recipient is associated with an alias, then the process moves to block 864 where the mobile or online banking system 600 adds the transfer cost and shows this transfer cost (if any) in a GUI. If, in block 862 of FIG. 8C, the mobile or online banking system 600 determines that the selected recipient is not associated with an alias, then the process moves to block 866 where the mobile or online banking system 600 does not show or add a transfer cost. The mobile P2P payment system client application 694 may display any possible transfer cost disclosure (along with the transfer cost in some embodiments) in a text box. In one embodiment, this cost disclosure text box is placed under the text input field where the first user enters the amount to be transferred.

The process then moves to block 868 of FIG. 8C where the first user enters a transfer amount (e.g., in the appropriate text input field).

The process then moves to block 870 of FIG. 8D where the P2P payment system client application 694 communicates the amount to be transferred to the mobile or online banking system 600.

The process then moves to block 872 of FIG. 8D where the mobile or online banking system 600 determines if the account selected by the first user for the transfer has sufficient funds to cover the amount of the transfer. In one embodiment, the mobile or online banking system 600 may also determine if the transfer amount is within a maximum transfer parameter (e.g., a predetermined maximum or a dynamically determined maximum).

If in block 872 of FIG. 8D the account does not have enough available funds to cover the transfer amount (e.g., the transfer amount is greater than the account's available funds) then the P2P payment system client application 694 displays an error message 874 to the first user.

If in block 872 of FIG. 8D the account has sufficient funds to cover the transfer amount, in block 875 the mobile or online banking system 600 places a hold on funds in the account sufficient to cover the transaction amount. For example, the mobile or online banking system 600 may transfer sufficient finds from the first user's account to the financial institution's general ledger. Once a hold has been placed on the funds sufficient to cover the transaction, these funds are no longer available to the first user unless the transfer is later canceled or modified. After placing a hold on the funds, the mobile or online banking system 600 assigns a payment certification code to the transaction. For example, the mobile or online banking system 600 may generate a unique payment certification code and store this unique code in a payment certification code database. Typically, this payment certification code must later by provided by the recipient to the mobile or online banking system 600 before the transaction is completed. The payment certification code is typically unique to the transaction and may be an alphanumeric code or a barcode (e.g., a two-dimensional barcode such as a QR code). The payment certification code may be automatically generated by the mobile or online banking system 600 once the hold has been placed on the funds. Alternatively, payment certification code may be generated by the mobile or online banking system 600 after the mobile or online banking system 600 receives a payment certification code request from the first user.

Next, in block 876 the P2P payment system client application 694 requests user confirmation of the transfer request 876. Here, the P2P payment system client application 694 typically displays the transfer-from account, the transfer-to account or recipient alias, the amount to be transferred, that the transfer is certified, and the cost to be incurred (if any) by the first user for making this transfer. The GUI may also displays cost disclosure text on the page. In some embodiments, there is no cost incurred by the first user for making the transfer. The GUI may also displays two buttons or hyperlinks, one for making the transfer and one for canceling the transfer and returning to the bank menu page.

The process then moves to block 878 of FIG. 8D where the first user confirms the transaction request by activating the button or hyperlink for making the transfer. If the mobile or online banking system 600 recognizes that this transaction is a duplicate of another transaction executed within a pre-determined amount of time in the past, then P2P payment system client application 694 may display another pre-confirmation page informing the first user that the transfer is a possible duplicate of a recently executed transaction. The GUI may display two buttons or hyperlinks, one for making the transfer and one for canceling the transfer and returning to the bank menu page.

In an alternative embodiment, the mobile or online banking system 600 may not place a hold on the funds for covering the transaction amount until after the first user confirms the transaction request.

The process then moves to block 879 of FIG. 8D where the P2P payment system client application 694 typically displays the payment certification code to the first user. For example, the graphical user interface of the P2P payment system client application 694 may display a barcode or alphanumeric code being used as the payment certification code. In some embodiments, the payment certification code is displayed upon the request of the first user (e.g., the first user requests that the P2P payment system client application 694 display the payment certification code). In other embodiments, the mobile or online banking system 600 may transmit the payment certification code to the first user using a message (e.g., via an instant message, an email message, or an SMS message) upon the request of the first user. In other embodiments, the mobile or online banking system 600 may automatically transmit or display the payment certification code to the first user. This payment certification code may later be provided by the first user to the recipient once the first user is ready to complete the transaction.

In one embodiment, the payment certification code generated by the mobile or online banking system 600 and provided to the first user is only valid for a predetermined amount of time. Once the predetermined amount of time has elapsed, the first user may be notified by the mobile or online banking system 600 that the payment certification code has expired. Afterwards, the first user may request that the mobile or online banking system 600 generate a new payment certification code and provide (e.g., transmit and/or display) this new payment certification code to the first user.

Next, the process moves to block 880 where the P2P payment system client application 694 displays information about the transfer to the first user and indicates that the transfer is pending.

The process then moves to block 881 of FIG. 8D where the mobile or online banking system 600 determines whether the recipient is associated with an alias or a financial institution account number.

If the recipient is associated with a financial institution account number, the process moves to block 882 where the mobile or online banking system 600 communications a certified payment notification to the recipient that informs the recipient of a pending transaction and that the transaction is certified (e.g., that the first user has sufficient funds to cover the transaction amount). The certified payment notification may inform the recipient that a payment certification code is required before the certified transfer will be completed. After communicating the certified payment notification to the recipient, the mobile or online banking system 600 waits to receive the certified payment notification from the recipient. In this regard, the first user may transmit the payment certification code to the recipient or display the payment certification code to the recipient with the first user's computing device. By way of further example, the first user may display a barcode with the computing device 400, which the second user can then scan with the computing device 500 and then transmit to the mobile or online banking system 600. In one embodiment, the recipient may use an intermediary to transmit the payment certification code to the mobile or online banking system 600. For example, the recipient may provide the payment certification code to the financial institution maintaining the recipient's account. This financial institution associated with the recipient may then transmit the payment certification code to the mobile or online banking system 600. Indeed, it within the scope of the present invention for the recipient to involve an intermediary (e.g., a financial institution) to communicate the payment certification code or to otherwise interact with the mobile or online banking system 600.

Next at block 886 after receiving the payment certification code from the recipient (e.g., from the recipient's computing device), the mobile or online banking system 600 uses the financial institution account number to initiate an Automated Clearing House (ACH) transfer or other type of transfer of funds to the recipient. For example, the mobile or online banking system 600 may transfer the held funds from the financial institution's general ledger to the recipient. In one embodiment, the mobile or online banking system 600 may compare the payment certification code transmitted by the recipient with the payment certification code associated with the transaction that is stored in a payment certification code database. If the payment certification code transmitted by the recipient does not match the payment certification code in the payment certification code database, the mobile or online banking system 600 may then generate and transmit an error message (e.g., to the first user and/or to the recipient) indicating that the payment certification provided by the recipient is incorrect and either cancel the transaction or provide another opportunity for the recipient to transmit the correct payment certification code.

Subsequently, the process moves to block 888 of FIG. 8D where the P2P payment system client application 694 provides notification to the first user that a transfer or a notice of transfer request to the recipient (second user) has been initiated and displays the information regarding the transfer to the first user. For example, the P2P payment system client application 694 may display a confirmation page that displays the transfer-from account, the transfer-to account or recipient alias, the amount transferred, the cost incurred by the first user for making this transfer, the total cost of the transfer, and the date on which the transfer was executed. The confirmation page may also displays a confirmation number associated with the transfer.

If, in block 881, the recipient is associated with an alias then, the process moves to block 883 where the mobile or online banking system 600 sends the alias and the recipient's name to an alias data repository 700.

The process then moves to block 884 where the alias data repository 700 looks up the alias in an alias datastore. Then the process moves to block 885, where the alias data repository 700 determines whether the alias is associated with a financial institution account. In some embodiments, the mobile or online banking system 600 will not generate the payment certification code and/or display the payment certification code to the first user until the mobile or online banking system 600 looks up the alias and determines that the alias is associated with a bank account. If the alias is associated with a financial institution account, then, if the alias data repository 700 determines that the provided name matches the name in the datastore, then the process moves to block 882 of FIG. 8D where the mobile or online banking system 600 then communicates (e.g., transmits) a payment certification notification to the recipient that informs the recipient of a pending P2P transaction and that the transaction is certified (e.g., that the first user has sufficient funds to cover the transaction amount). Once the notification has been transmitted to the recipient, the mobile or online banking system 600 then waits for the recipient to provide the payment certification code.

Once the recipient provides the payment certification code to the mobile or online banking system 600, the process moves to block 886 where the mobile or online banking system 600 initiates a transfer of the funds. Subsequently, the process moves to block 888 of FIG. 8D where the P2P payment system client application 694 provides notification to the first user that a transfer or a notice of transfer request to the recipient (second user) has been initiated and displays the information regarding the transfer to the first user. For example, the P2P payment system client application 694 may display a confirmation page that displays the transfer-from account, the transfer-to account or recipient alias, the amount transferred, the cost incurred by the first user for making this transfer, the total cost of the transfer, and the date on which the transfer was executed. The confirmation page may also displays a confirmation number associated with the transfer.

In one embodiment, the mobile or online banking system 600 may receive instructions from the first user to modify or cancel the transaction before the recipient transmits the payment certification code. If the first user transmits instructions to cancel the transactions, the mobile or online banking system 600 will then typically cancel the transaction and transmit transaction cancelation notification to the first user and/or to the recipient. Once the transaction has been canceled, the hold on the funds is removed by the mobile or online banking system 600. For example, the funds may be transferred back to the first user's account from the financial institution's general ledger.

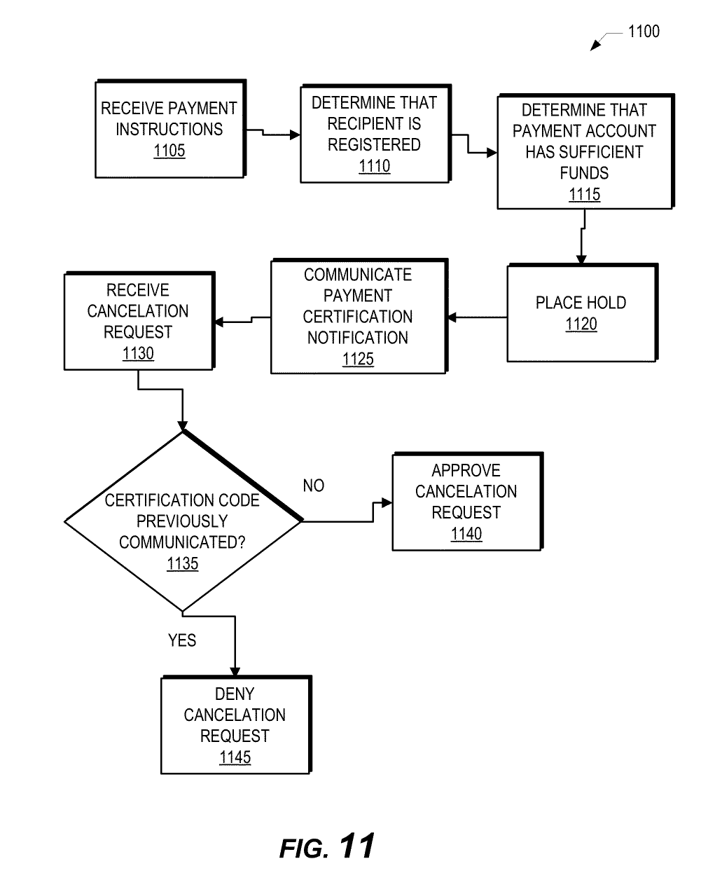

In one embodiment, the mobile or online banking system 600 may only permit the first user to cancel the transaction before the payment certification code is communicated to the first user. Such an exemplary method 1100 for canceling a pending transaction is depicted in FIG. 11. In step 1105, the mobile or online banking system 600 receives payment instructions, which typically include a payment account, a payment amount, an alias associated with a recipient from the first user. In step 1110, the mobile or online banking system 600 determines that the recipient is a registered recipient based on the alias in the payment instructions. In step 1115, the mobile or online banking system 600 determines that the payment account has funds sufficient to cover the payment amount. After the mobile or online banking system 600 determines that the payment account has funds sufficient to cover the payment amount, in step 1120 the mobile or online banking system 600 places a hold on funds in the payment account sufficient to cover the payment amount. For example, the mobile or online banking system 600 may transfer funds in the payment account sufficient to cover the payment amount to the financial institution's general ledger. In step 1125, a certified payment notification is communicated to the recipient based upon determining that the payment account has funds sufficient to cover the payment amount and determining that the recipient is a registered recipient based on the alias. In step 1130, the mobile or online banking system 600 receives a payment cancelation request from the first user. Next, the mobile or online banking system 600 determines whether a payment certification code has been communicated to the first user in step 1135. For example and as discussed herein, the mobile or online banking system 600 may have previously transmitted or displayed the payment certification code to the first user based upon receiving a payment certification code request from the first user. If a payment certification code has not yet been communicated to the first user, the mobile or online banking system 600 approves the cancelation request in step 1140. Once the cancelation request has been approved, the mobile or online banking system 600 removes the hold placed on the funds. For example, the mobile or online banking system 600 may transfer funds in the financial institution's general ledger sufficient to cover the payment amount back to the payment account. In addition, a payment cancelation notification may be communicated to the first user and/or to the recipient to inform them that the transaction has been canceled. If a payment certification code has been communicated to the first user, in step 1145 the mobile or online banking system 600 denies the cancelation request. If the payment cancelation request is denied, then the mobile or online banking system 600 may subsequently complete the transaction as discussed herein (e.g., by transferring the held funds to an account associated with the recipient), if then the mobile or online banking system 600 receives the payment certification code from the recipient.

If the first user transmits instructions to reduce the transaction amount, the mobile or online banking system 600 will typically reduce the transaction amount (e.g., reducing the amount of held funds to the reduced transaction amount) and transmit a notification to the first user and/or to the recipient indicating that the amount of the transaction has changed. If the first user transmits instructions to increase the transaction amount, the mobile or online banking system 600 will then determine if the user has funds sufficient to cover the increased transaction amount, and, if so, place a hold on funds sufficient to cover the increased transaction amount and transmit a notification to the first user and/or to the recipient indicating that the amount of the transaction has changed. In addition, the mobile or online banking system 600 may assign a new payment certification code to the transaction or may continue to use the previously assigned payment certification code. If the first user does not have enough available funds to cover the increased transaction amount, the mobile or online banking system 600 will then typically cancel the transaction and transmit transaction cancelation notification to the first user and/or to the recipient. In one embodiment, the first user can only modify the transaction amount if the payment certification code has not yet been communication to the first user.

If in block 885 of FIG. 8D, the alias data repository 700 determines that the alias is not associated with a financial institution account, then the process moves to block 890 of FIG. 8E where the mobile or online banking system 600 determines whether if the recipient (second user) has an eligible financial institution account. If the recipient (second user) does not have an eligible financial institution account, then in block 892, the mobile or online banking system 600 uses an alias to send the recipient notification of requested transfer from the first user and an offer to open a financial institution account with the financial institution that manages the mobile or online banking system 600. This notification will also typically inform the recipient that the transaction is certified (e.g., that the first user has sufficient funds to cover the transaction amount). In one embodiment, the alias is a phone number or an email address.

The process then moves on from block 892 to block 893 of FIG. 8E, where if the second user decides to not open a financial institution account at the financial institution that manages the mobile or online banking system 600, then the mobile or online banking system 600 cancels the transfer and notifies the first user in block 899.

If in block 893 of FIG. 8D, the second user (recipient) decides to open a new financial institution account, the mobile or online banking system 600, in block 895, opens a new account for the second user. Subsequently, the second user (recipient) must determine in block 894 whether the second user registers the new financial institution account for the P2P service.

As shown in FIG. 8E, if the second user in block 894 does not register the new financial institution account opened in block 895, then the mobile or online banking system 600 cancels the transfer and notifies the first user in block 899.

As shown in FIG. 8E, if the second user registers the new financial institution account in block 894 for mobile P2P transfers, then the mobile or online banking system 600 waits to receive the payment certification code from the recipient and, then, in block 896, uses the new registered financial institution account to initiate an ACH transfer or other type of transfer. The process then moves to block 897 where the mobile or online banking system 600 sends the alias and the new registered account information to the alias data repository 700. The process then moves to block 898 of FIG. 8E where the alias data repository 700 stores the recipient's alias in the alias datastore along with the recipient's (second user's) new registered financial institution account.

If the recipient (second user) has an eligible financial institution account as determined by the mobile or online banking system 600 in block 890, then the process moves to block 891 in FIG. 8E where the mobile or online banking system 600 uses an alias (e.g., phone number or email address) to send recipient (second user) notification of requested transfer, and offers to register the recipient's financial institution account and alias. This notification will also typically inform the recipient that the transaction is certified (e.g., that the first user has sufficient funds to cover the transaction amount). As shown in FIG. 8E, then the process moves to block 894 where if the second user (recipient) decides not to register the second user's financial institution account for P2P transfers, then the mobile or online banking system 600 cancels the transfer and notifies the first user.

As shown in FIG. 8E, if the second user (recipient) registers the eligible financial institution account in block 894, then the mobile or online banking system 600 waits to receive the payment certification code from the recipient and, then, in block 896, uses the new registered financial institution account to initiate an ACH transfer or other type of transfer. The process then proceeds to block 897 where the mobile or online banking system 600 sends alias and the eligible registered account information to the alias data repository 700. The process then moves to block 898 of FIG. 8E where the alias data repository 700 stores the recipient's alias in the alias datastore along with the recipient's eligible registered financial institution account.

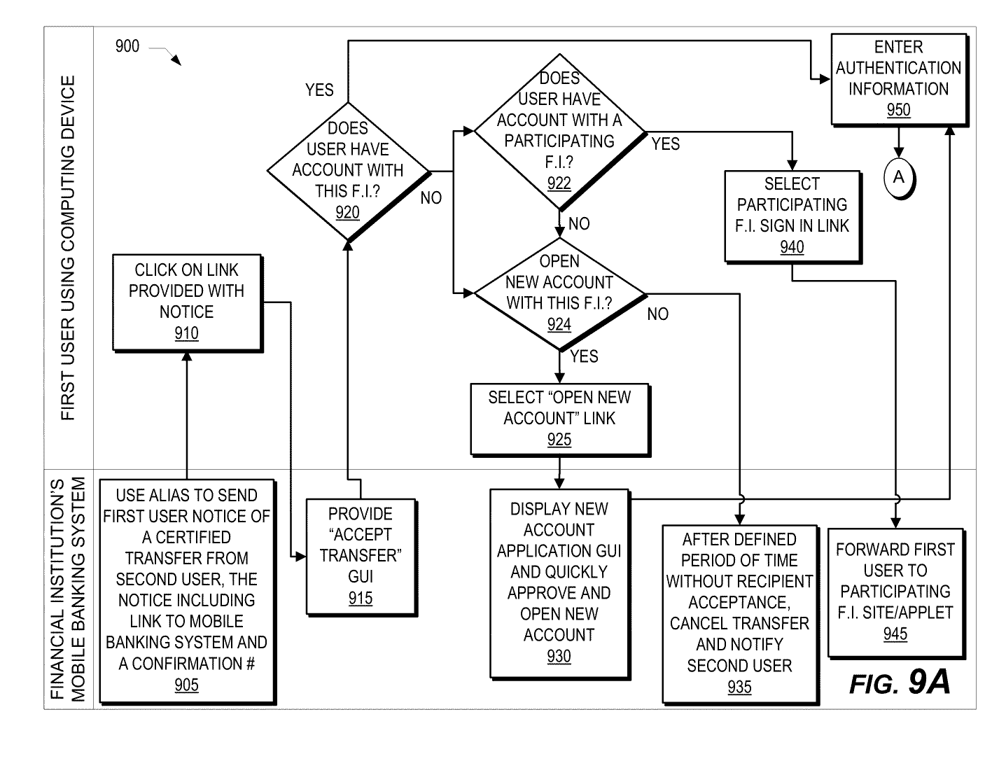

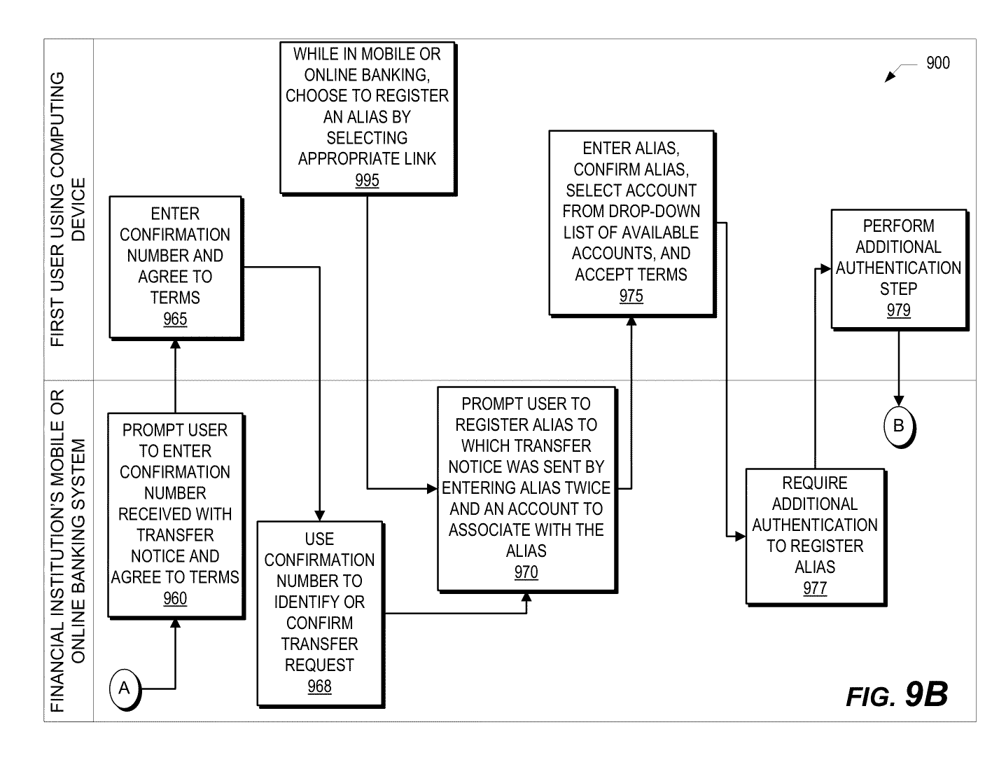

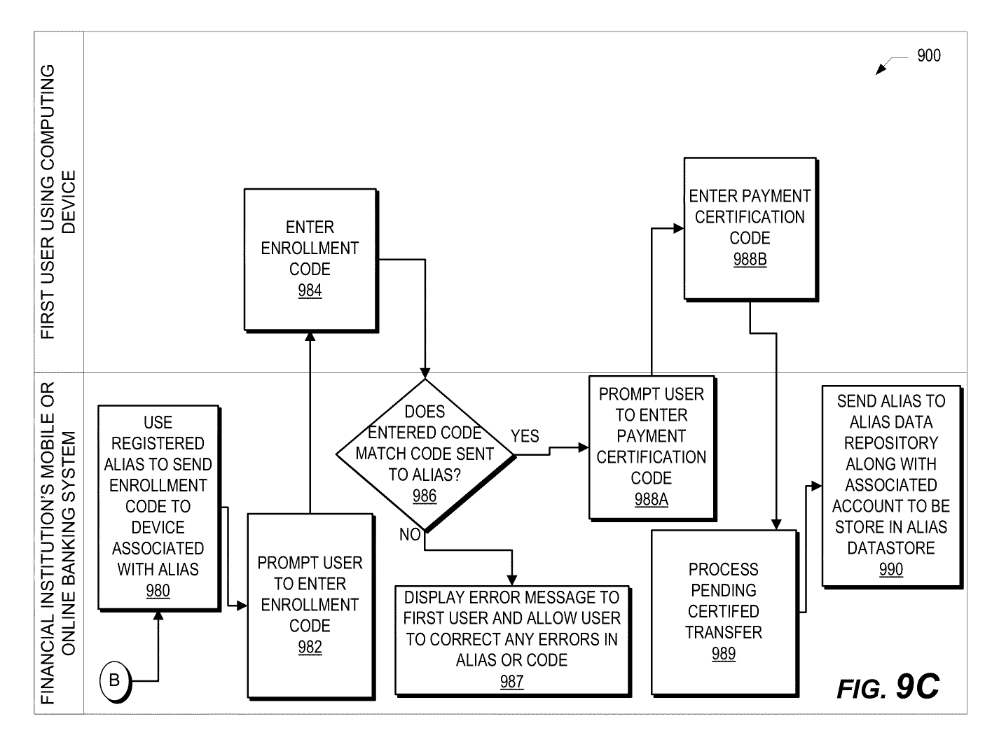

FIGS. 9A-9C provide flow charts illustrating a process 900 for receiving certified P2P payments, in accordance with an embodiment of the invention. FIGS. 9A-9C illustrate the flow chart in terms of “swim lanes” associated with entities which may perform the operations in each respective swim lane. The entities illustrated in the exemplary Figures are a financial institution's mobile or online banking system 600 and a first user (recipient) using a first computing device (e.g., a mobile device). However, it should be noted that other entities could also be involved and some embodiments of the invention may not be limited to the two entities illustrated in FIGS. 9A-9C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process 900 in FIG. 9A starts with block 905 where a mobile or online banking system 600 sends a first user (recipient) notice of a requested certified transfer from a second user, the notice including a link to the mobile or online banking system 600 and a confirmation number. The notice also typically includes a notification (e.g., a certified payment notification) that informs the recipient that the transaction is certified (e.g., that the second user has sufficient funds to cover the transaction amount). The certified payment notification may inform the first user that a payment certification code is required before the certified transfer will be completed.

The process then proceeds to block 910 where a first user (recipient) activates the link provided with the notice.

The mobile or online banking system 600 alerts the first user (recipient) that to accept the transfer, the first user will need an eligible checking or saving account at a participating financial institution at block 915. For customers who hold accounts at the financial institution that manages the mobile or online banking system 600, the mobile or online banking system 600 presents a widget with a textbox that allows the first user to enter login or other authenticating information. The mobile or online banking system 600 also provides a link for the first user to enroll with the financial institution's mobile or online banking system. For customers of other participating financial institutions, the mobile or online banking system 600 provides a sign-in button, which might either display a sign-in widget on the instant page or might provide for a link to another page where the first user can enter login information for the participating financial institution. The mobile or online banking system 600 also notifies the first user that if the first user does not have an account with one of the participating banks, that first user can open an account at the financial institution that maintains the mobile or online banking system 600. The mobile or online banking system 600 notifies the first user that he or she may review the terms of opening a new account at this financial institution, including any costs that may be incurred by the first user in opening this new account. The mobile or online banking system 600 also notifies the first user that if the first user does not want to open a new financial institution account, the first user may notify the sender to arrange an alternate transfer method. The mobile or online banking system 600 also notifies the first user that the transaction will be canceled if it is not accepted within a pre-determined period of time.

The process then proceeds to block 920 of FIG. 9A where the first user (recipient) determines whether the first user has an account with the financial institution that manages the mobile or online banking system 600. If the first user has a financial institution account with the financial institution that manages the mobile or online banking system 600, then the process moves to block 950 where the first user enters authentication information into the appropriate textbox.

As shown in FIG. 9A, if the first user does not have a financial institution account with the financial institution that manages the mobile or online banking system 600 then the process proceeds to block 922 where the first user determines whether the first user has an account with participating financial banks or financial institutions. If the first user has a financial institution account with a participating financial institution, the process proceeds to block 940 where the first user can select the participating financial institution sign-in link. The process then moves to block 945 where the mobile or online banking system 600 forwards the first user to a participating financial institution's website or alternatively, the mobile or online banking system 600 opens a widget or an applet on the same window or new pop-up window.

As shown in FIG. 9A, if, in block 920, the first user does not have an account the financial institution that manages the mobile or online banking system 600 and if, in block 924, the first user (recipient) does not open a new account with the financial institution that manages the mobile or online banking system 600, then, as shown in block 935, after a defined period of time without recipient (first user) acceptance, the mobile or online banking system 600 cancels the transfer and notifies the second user (sender).

As shown in FIG. 9A if, in block 924, the first user opens a new account with the financial institution that manages the mobile or online banking system 600, then the first user, in block 925, selects the link directing the first user to open a new account with the financial institution that manages the mobile or online banking system 600.

As shown in FIG. 9A, the link in block 925 directs the mobile or online banking system 600 to display a new account application GUI to the first user (see block 930), which new account application quickly approves and opens a new account for the first user after receiving any pertinent information that may be required to open and be approved for a new account at the financial institution that manages the mobile or online banking system 600. The process then proceeds to block 950 in FIG. 9A where the first user enters authentication information into a textbox.

The process then moves to block 960 in FIG. 9B where the mobile or online banking system 600 prompts the first user to enter a confirmation number received with the transfer notice and agree to the terms governing the transfer. The mobile or online banking system 600 indicates to the first user that this is the start of the procedure to accept a transfer to money to the first user's email address or mobile number. The mobile or online banking system 600 prompts the first user to enter the received confirmation number in a textbox. The webpage also typically has two buttons—a first button configured to allow the first user to indicate a desire not to proceed with accepting the transfer and a second button configured to allow the first user to indicate a desire to proceed with the transfer. In one embodiment, the second button can move from a dormant state to an activatable state by checking the check-box to confirm that the first user has a) has read and agrees to the terms of the service agreement, including the terms of the Email/Mobile Network Transfer section; b) consents to receive email and automated text messages about Email/Mobile Transfers; c) will only register mobile numbers where the first user is the account holder; or if the first user is not the account holder, he or she has the account holder's permission to register that mobile number; and d) will obtain the consent of the person to whom he or she wants to send a Mobile Transfer text message to receive the automated text message. In one embodiment, the first user has to always go through the procedure of accepting the transfer. In other embodiments, the first user does not have to go through the procedure accepting the transfer for any transfer after the first transfer.

Subsequently, in block 965, the first user enters a confirmation number in the appropriate textbox and agrees to the terms that govern the transaction by activating the appropriate checkbox. The first user then activates on the second button to continue the process of accepting the transfer.

The process then moves to block 968 of FIG. 9B where the mobile or online banking system 600 uses the confirmation number entered in block 965 to identify or confirm the transfer request. In some embodiments, the first user, while using mobile or online banking may choose to register an alias by selecting the appropriate link, as illustrated in block 995.

Then the process proceeds to block 970 of FIG. 9B where the mobile or online banking system 600 prompts the user to register the alias to which the transfer notice was sent. The mobile or online banking system 600 indicates to the first user that if the first user has received a certified transfer notice, then the first user will need to set up to accept transfers with the same email address or mobile number that received the transfer notice. The page typically shows a first textbox where the user can enter the alias that received the transfer notice, and a second textbox where the user can confirm the alias entered in the first textbox by re-entering the alias in the second textbox. The mobile or online banking system 600 also prompts the user to select the appropriate account to link to the alias that will receive the funds by selecting the appropriate account from a drop down list. The mobile or online banking system 600 also prompts the user to check a checkbox, whereby the first user by checking the checkbox agrees that by registering the alias, he or she is the alias account holder, or has the alias account holder's permission to register it, and consents to receive email and text messages about alias transfers at this email address or phone number. In some embodiments, the mobile or online banking system 600 presents an authentication widget that will be described in further detail below. The page also has two buttons—a first button configured to allow the first user to indicate a desire not to proceed with receiving the transfer and a second button configured to allow the first user to indicate a desire to proceed with receiving the transfer. This second button moves from a dormant state to an activatable state after the first user enters all the required information on the page and has been further authenticated, as in some embodiments. In one embodiment, the mobile or online banking system 600 also saves the information entered on this page, so that the first user does not have to re-register an alias every time the first user receives a certified P2P transfer.

The process then proceeds to block 975 where the first user enters the alias in the appropriate textbox, confirms the alias in the appropriate textbox, selects the account to receive the funds from the drop-down list, and checks the checkbox that indicates that the first user accepts the terms that govern the transfer. In some embodiments, the accounts listed in the drop-down list are identified only by selected few digits of the account numbers.

In some embodiments, the process then proceeds to block 977 where the mobile or online banking system 600 requires additional authentication to register an alias. The mobile or online banking system 600 displays a widget which serves as an additional authenticating step before saving the information of the first user's associated alias. The mobile or online banking system 600 may indicate to the first user that by activating in the widget a button for a sending an authentication code, the first user will receive an authentication code on his or her mobile device. In another embodiment, the first user may receive an authentication code through other means such as email or snail mail.

The process then moves to block 979 of FIG. 9B where the first user performs the additional authentication step. The first user activates on the widget's button for sending an authentication code to the first user's computing device. The first user then receives on his or her computing device the authentication code that he or she must input into the widget. Once the first user inputs the correct authentication code into the widget and presses a button in the widget to confirm that the authentication code is correct, the button that corresponds to adding a new recipient is activated so that it can now be activated by the first user. The first user (recipient) activates this button so that the mobile or online banking system 600 can store the first user's alias. The first user can activate a designated button on the page which indicates that the first user wishes to proceed with receiving the certified transfer. The mobile or online banking system 600 indicates to the first user that by activating the button to continue with receiving the certified transfer, the first user will receive an enrollment code.

The process then moves to block 980 of FIG. 9C where the mobile or online banking system 600 uses the registered alias to send an enrollment code to the device of the first user (recipient) associated with the alias.

The process then moves to block 982 of FIG. 9C where the mobile or online banking system 600 prompts the first user to enter the enrollment code that the first user received on the device associated with the alias. The mobile or online banking system 600 indicates to the first user that the first user must verify the alias (e.g., mobile number) to complete enrollment in the certified P2P transfer service. In one embodiment, the webpage indicates to the first user that the first user should expect a text message from the financial institution that manages the mobile or online banking system 600. The page also has activatable text if the first user would like to know more about the use of enrollment codes. The page indicates to the first user, the enrollment code must be entered into the appropriate textbook in order verify ownership of the mobile number or email address associated with the alias and complete enrollment with the P2P transfer service. The mobile or online banking system 600 also indicates to the first user that the enrollment number expires in a pre-determined number of minutes. After the enrollment number expires, the mobile or online banking system 600 will not be able use that enrollment code to verify ownership of the first user's mobile number associated with the transfer and will not be able to complete the enrollment of the first user (recipient). The webpage also has activatable text to get help if the first user has not received an enrollment code or if the enrollment code has expired. The page indicates to the first user that messaging and data rates may apply for receiving the enrollment code. The page also has two buttons—a first button configured to allow the first user to indicate a desire not to proceed with the transaction and a second button configured to allow the first user to indicate a desire to proceed with receiving the transfer. The second button only moves from a dormant state to an activatable state after the first user enters an enrollment code on the page. In an embodiment, the second button only becomes activatable after the first user enters a valid and unexpired enrollment code on the page.

The process then moves to block 984 where the first user enters the enrollment code into the appropriate textbox.

The process then moves block 986 where the mobile or online banking system 600 determines if the enrollment code entered by the first user matches the enrollment code sent by the mobile or online banking system 600 to the alias of the first user.

If the entered code in 986 does not match the code sent to the alias, then the mobile or online banking system 600 displays an error message to the first user that the transaction cannot move any further. In one embodiment, the mobile or online banking system 600 allows the first user to correct any errors in the alias provided by the first user or in the code received by the first user. In one embodiment, the mobile or online banking system 600 only grants a pre-determined number of unsuccessful attempts to verify the code before rejecting the transfer.

The process then moves to block 988A of FIG. 9C where the mobile or online banking system 600 prompts the first user to enter the payment certification code associated with the certified P2P transfer.

At block 988B the first user enters the payment certification code. As described above, the payment certification code is provided by the payer (here the second user) to the payee (here the first user) when the payer is ready to complete the transaction. In one embodiment, the first user enters an alphanumeric payment certification code provided by the second user into the appropriate textbox. In another embodiment, the first user may use his or her computing device to scan a payment certification barcode displayed on the second user's computing device. If the first user enters an incorrect payment certification code, the mobile or online banking system 600 may prompt the first user to try again or may cancel the transaction (e.g., cancel the transaction after a predetermined number of attempts to enter the correct payment certification code). For example, the mobile or online banking system 600 may prompt the first user to try again if the first user enters a payment certification code that is associated with a transaction in which the first user is not the recipient. Accordingly, the first user typically can only successfully enter payment certification codes associated with an alias of the first user. Similarly, another user who has acquired a payment certification code associated with the first user typically cannot use such a payment certification code to acquire funds intended for the first user.

If the entered payment certification code in 988B matches the payment certification code associated with the certified transaction, the process moves to block 989 where the mobile or online banking system 600 completes the certified transfer by transferring the certified funds to the first user's registered account.

In addition, the mobile or online banking system 600 may indicate to the user that the verification of the alias has been completed. The mobile or online banking system 600 may thank the user for setting up an alias to accept transfers. The mobile or online banking system 600 may indicate to the first user that people or entities can now send money to the first user using the first user's alias. The mobile or online banking system 600 may indicate to the first user that any transfer to the first user's newly registered alias will be deposited to the account number shown on the webpage. In one embodiment, the mobile or online banking system 600 only shows a selected few digits of the first user's financial institution account number. The page also indicates to the first user that the transfer request is now in process. The page shows details of the transfer, including, but not limited to the name of the sender, the amount, the date on which the sender sent the amount, the confirmation number, and the status of the transfer. The page also two buttons. The first button allows the first user to add another alias and the second button allows the first user make a transfer using the newly registered alias.

The process then moves to block 990 where the mobile or online banking system 600 sends the alias to the alias data repository 700 along with associated account information to be stored in the alias datastore.

In one embodiment, the mobile or online banking system 600 presents four hyperlinks under the transfers hyperlink described earlier. These four hyperlinks are a hyperlink for a making a certified transfer, a hyperlink for reviewing transfers, a hyperlink for adding recipients, and a hyperlink for managing accounts. In one embodiment, the mobile or online banking system 600 may also present a hyperlink for making a non-certified transaction. Using the appropriate hyperlink, the first user has the option of obtaining set up to accept transfer by activating an appropriate link. The mobile or online banking system 600 indicates to the first user (recipient) that the first user may activate the link if the first user received a transfer notice (e.g., if the first user received an email, text message, or other form of electronic communication that someone has sent money to the first user). The mobile or online banking system 600 indicates to the first user that in order to complete the transfer and collect the funds, the first user must set up the first user's alias to accept transfers. The mobile or online banking system 600 also presents an activatable link so that the first user can be directed to a page to learn more about this P2P transfer via alias method. The mobile or online banking system 600 also presents a help box where the first user can understand more about what the first user can do using the mobile or online banking system 600, what the first user needs to know, and what else the first user can do using the mobile or online banking system 600. The mobile or online banking system 600 also presents a message to the first user that transferring money within the bank is fast and free. The mobile or online banking system 600 also indicates to the customer that the feature of making a P2P transfer using a recipient's alias is a new feature, and that transfers within the bank now include transfers made using a recipient's alias. Alternatively, a user who intends to receive money using an alias can get set up by activating the link associated with obtaining a set up to accept transfers. A user who accesses the mobile or online banking system 600 can register an alias by selecting an appropriate link. Therefore, in one embodiment, the user does not have to wait to receive a certified payment using the P2P transfer service before setting up an alias to receive transfers. In one embodiment, the user can register an alias using a computing device (e.g., a mobile device).

In one embodiment of the present invention, both the sender and the recipient need to have financial institution accounts registered for certified P2P transfers via an alias. In another embodiment of the present invention, the sender needs to have a financial institution account registered for certified P2P transfers via an alias, but the recipient does not need to have a financial institution account registered for certified P2P transfers via an alias. In another embodiment of the present invention, the recipient needs to have a financial institution account registered for certified P2P transfers via an alias, but the sender does not need to have a financial institution account registered for certified P2P transfers via an alias.

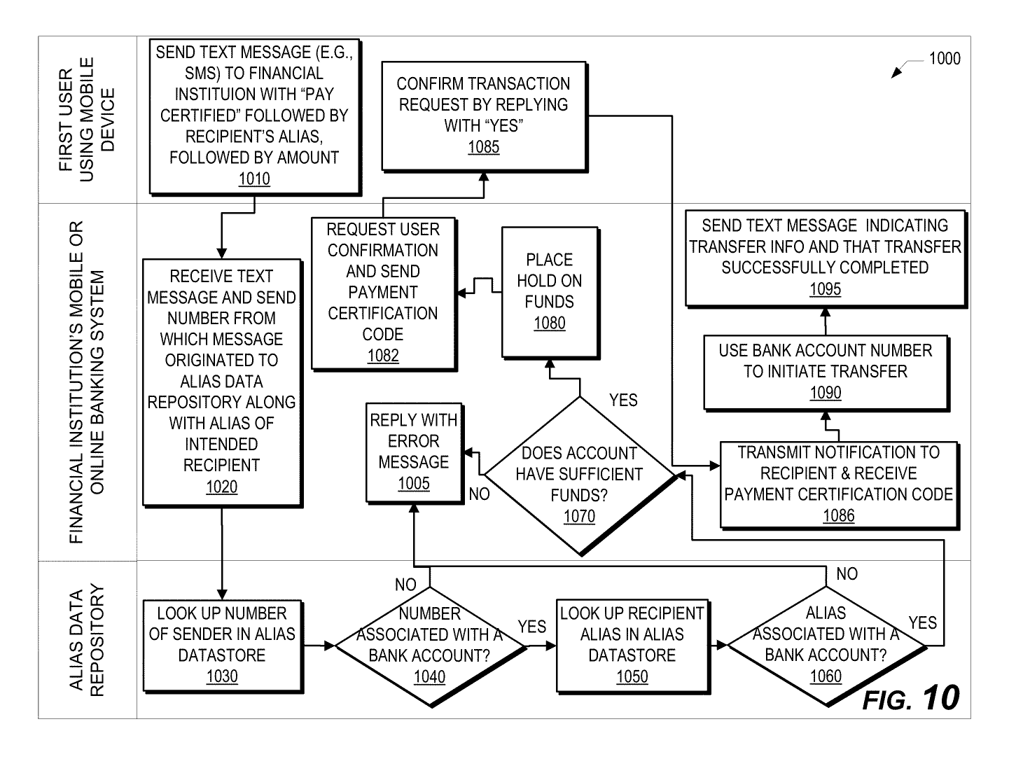

FIG. 10 provides a flow chart illustrating a process 1000 for sending certified P2P payments via text message, in accordance with an embodiment of the invention. FIG. 10 illustrates the flow chart in terms of “swim lanes” associated with entities which may perform the operations in each respective swim lane. The entities illustrated in the exemplary Figure are a financial institution's mobile or online banking system 600, a first user (sender) 310 using a first mobile device 400, and an alias data repository 700. However, it should be noted that other entities could also be involved and some embodiments of the invention may not be limited to the three entities illustrated in FIG. 10. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

All features that are described above as being part of the certified P2P payment process and interface are also part of the text message P2P payment process and service. In one embodiment of the invention, the text message certified P2P payment send process and interface is a feature provided in the certified P2P payment send process and interface. In another embodiment of the invention, the text message certified P2P payment send process and interface is distinct from the certified P2P payment send process and interface. This text message certified P2P transfer feature is particularly useful for users who carry mobile devices that do not have computing resources and cannot access the Internet (e.g., for mobile devices that only have messaging features and can only access a phone network).

Referring to FIG. 10, the process starts in block 1010 of FIG. 10 where the first user 310 (sender) sends a text message to a phone number associated with a mobile or online banking system 600 in a format that is recognized by the mobile or online banking system 600. In one embodiment, the format includes the words “Pay Certified” followed by the recipient's alias followed by the amount that the first user intends to transfer.

The process then moves to block 1020 in FIG. 10 where the mobile or online banking system 600 receives the text message from the first user and sends the number from which the message originated to the alias data repository 700 along with the alias of intended recipient.

The process then moves to block 1030 in FIG. 10 where the alias data repository 700 looks up the number of the first user (sender) in the alias datastore.

The process then moves to block 1040 in FIG. 10 where the alias data repository 700 determines if the number of the first user is a number associated with a financial institution account. If the alias data repository 700 determines that the number of the first user is not a number associated with a financial institution account, the mobile or online banking system 600 replies to the first user with an error message that the transaction cannot be completed (see block 1005). In one embodiment, the error message is sent via text message, however, in other embodiments, the error message can be sent by any form of communication such as email, placing a phone call to the first user, or snail mail.

If, in block 1040, the alias data repository 700 determines that the number of the first user is a number associated with a financial institution account, then the process moves to block 1050 in FIG. 10 where the alias data repository 700 looks up the recipient alias in the alias data store.

The process then moves to block 1060 in FIG. 10 where the alias data repository 700 determines if the recipient's alias is associated with a financial institution account. If the alias data repository 700 determines that the recipient alias is not associated with a financial institution account, the mobile or online banking system 600 replies to the first user with a graceful error message that the transaction cannot be completed (see block 1005). In one embodiment, the error message is sent via text message, however, in other embodiments, it can be sent by any form of communication such as email, placing a phone call to the first user, or snail mail.

If, in block 1060, the alias data repository 700 determines that the recipient alias is associated with a financial institution account, then the process moves to block 1070. At block 1070, the mobile or online banking system 600 determines whether the first user's account has sufficient funds to cover the amount of the transaction. If the mobile or online banking system 600 determines that the first user's account does not have enough funds to cover the transaction amount, then the mobile or online banking system 600 replies to the first user with an error message that the transaction cannot be completed (see block 1005). In one embodiment, the error message is sent via text message, however, in other embodiments, it can be sent by any form of communication such as email, placing a phone call to the first user, or snail mail.

If, in block 1070, the mobile or online banking system 600 at block 1080 determines that the first user's account has sufficient funds, then the mobile or online banking system 600 places a hold on funds sufficient to cover the transaction amount and assigns a payment certification code to the transaction.

Next at block 1082, the mobile or online banking system 600 sends a text message to the first user (i) showing the requested transfer with the recipient name associated with the alias, (ii) showing the payment certification code (e.g., an alphanumeric code) associated with the transaction, and (iii) requesting that the first user confirm the transfer request, wherein the format of the return confirmation text message is specified in the text message. In one embodiment, the recipient name associated with the alias is received from the alias data repository 700. In one embodiment, the text message in 1080 sent from the mobile or online banking system 600 specifies that the first user can confirm the transfer request with a “Yes” and can reject the transfer request with a “No.” In other embodiments, the “Yes” and the “No” can be any letters, characters, or combinations thereof as defined by the mobile or online banking system 600. In one embodiment, the mobile or online banking system 600 does not send a text message to the first user that includes the payment certification code until after the first user sends a text message to the mobile or online banking system 600 that requests the payment certification code.

The process then moves to 1085 where the first user confirms the transaction request by replying to text message in 1080 with a “Yes.” In other embodiments, the first user can confirm the transaction request in the format as specified in the text message sent in 1080 from the mobile or online banking system 600 to the first user.

The process then moves to block 1086 where the mobile or online banking system 600 transmits a notification a certified payment notification to the recipient that informs the recipient of a pending transaction and that the transaction is certified (e.g., that the second user has sufficient funds to cover the transaction amount). The certified payment notification may inform the first user that a payment certification code is required before the certified transfer will be completed. Subsequently, the mobile or online banking system 600 receives the payment certification from the recipient. In this regard, the first user may provide the payment certification code to the recipient, who then transmits the payment certification code to the mobile or online banking system 600.

The process then moves to block 1090 where the mobile or online banking system 600 uses the first user's and the recipient's financial institution account numbers to initiate ACH or other type of transfer from the financial institution account associated with the first user's (sender's) phone number to the financial institution account associated with the recipient's alias.

The process then moves to block 1095 where the mobile or online banking system 600 sends a text message to the first user with information regarding the transfer and with a message that the transfer was successfully completed. The text message may also provide the first user with a confirmation number for the transfer.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing certified payments, comprising:
a computer apparatus including a processor and a memory; and
a certified payment system module stored in the memory, executable by the processor and configured to:
receive payment instructions from a payer computing device, wherein the payment instructions include a payment account, a payment amount, an alias associated with a payee, and a payment certification request;
determine that the payee is a registered payee based on the alias;
determine that the payment account has funds sufficient to cover the payment amount;
place a hold on funds in the payment account sufficient to cover the payment amount;
communicate a certified payment notification to the payee based up determining that the payment account has funds sufficient to cover the payment amount and determining that the payee is a registered payee based on the alias;
receive a payment cancelation request from the payer;
determine whether a payment certification code has been communicated to the payer; and
if a payment certification code has not been communicated to the payer, approve the payment cancelation request.

2. The system for providing certified payments according to claim 1, wherein the certified payment system module is configured to, based upon approving the payment cancelation request, remove the hold on the funds sufficient to cover the payment amount, communicate a payment cancelation notification to the payer, and communicate a payment cancelation notification to the payee.

3. The system for providing certified payments according to claim 2, wherein:
placing a hold on funds in the payment account sufficient to cover the payment amount comprising transferring funds in the payment account sufficient to cover the payment amount to a financial institution general ledger; and
removing the hold on the funds sufficient to cover the payment amount comprising transferring the funds in the financial institution general ledger sufficient to cover the payment amount to the payment account.

4. The system for providing certified payments according to claim 1, wherein the certified payment system module is configured to:
before receiving the payment cancelation request from the payer, communicate a payment certification code to the payer based upon determining that the payment account has funds sufficient to cover the payment amount;
determine that the payment certification code has been communicated to the payer;
based upon determining that the payment certification code has been communicated to the payer, deny the payment cancelation request and communicate a cancelation request denial notification to the first user.

5. The system for providing certified payments according to claim 4, wherein communicating a payment certification code to the payer comprises:
receiving a payment certification code request from the payer; and
thereafter, communicating the payment certification code to the payer based upon determining that the payment account has funds sufficient to cover the payment amount.

6. The system for providing certified payments according to claim 4, wherein the certified payment system module is configured to:
receive the payment certification code from a payee computing device; and
transfer the funds sufficient to cover the payment to an account associated with the payee based upon receiving the payment certification code from the payee computing device.

7. The system for providing certified payments according to claim 6, wherein:
placing a hold on funds in the payment account sufficient to cover the payment amount comprising transferring funds in the payment account sufficient to cover the payment amount to a financial institution general ledger; and
transferring the funds sufficient to cover the payment to an account associated with the payee comprises transferring the funds sufficient to cover the payment from the financial institution general ledger to an account associated with the payee.

8. A computer program product for providing certified payments, comprising a non-transitory computer-readable storage medium having computer-executable instructions for:
receiving payment instructions from a payer computing device, wherein the payment instructions include a payment account, a payment amount, an alias associated with a payee, and a payment certification request;
determining that the payee is a registered payee based on the alias;
determining that the payment account has funds sufficient to cover the payment amount;
placing a hold on funds in the payment account sufficient to cover the payment amount;
communicating a certified payment notification to the payee based up determining that the payment account has funds sufficient to cover the payment amount and determining that the payee is a registered payee based on the alias;
receiving a payment cancelation request from the payer;
determining whether a payment certification code has been communicated to the payer; and
if a payment certification code has not been communicated to the payer, approving the payment cancelation request.

9. The computer program product according to claim 8, wherein the non-transitory computer-readable storage medium has computer-executable instructions for, based upon approving the payment cancelation request, removing the hold on the funds sufficient to cover the payment amount, communicating a payment cancelation notification to the payer, and communicating a payment cancelation notification to the payee.

10. The computer program product according to claim 8, wherein:
placing a hold on funds in the payment account sufficient to cover the payment amount comprising transferring funds in the payment account sufficient to cover the payment amount to a financial institution general ledger; and
removing the hold on the funds sufficient to cover the payment amount comprising transferring the funds in the financial institution general ledger sufficient to cover the payment amount to the payment account.

11. The computer program product according to claim 8, wherein the non-transitory computer-readable storage medium has computer-executable instructions for:
before receiving the payment cancelation request from the payer, communicating a payment certification code to the payer based upon determining that the payment account has funds sufficient to cover the payment amount;
determining that the payment certification code has been communicated to the payer;
based upon determining that the payment certification code has been communicated to the payer, denying the payment cancelation request and communicate a cancelation request denial notification to the first user.

12. The computer program product according to claim 8, wherein communicating a payment certification code to the payer comprises:
receiving a payment certification code request from the payer; and
thereafter, communicating the payment certification code to the payer based upon determining that the payment account has funds sufficient to cover the payment amount.

13. The computer program product according to claim 8, wherein the non-transitory computer-readable storage medium has computer-executable instructions for:
receiving the payment certification code from a payee computing device; and
transferring the funds sufficient to cover the payment to an account associated with the payee based upon receiving the payment certification code from the payee computing device.

14. The computer program product according to claim 8, wherein:
placing a hold on funds in the payment account sufficient to cover the payment amount comprising transferring funds in the payment account sufficient to cover the payment amount to a financial institution general ledger; and
transferring the funds sufficient to cover the payment to an account associated with the payee comprises transferring the funds sufficient to cover the payment from the financial institution general ledger to an account associated with the payee.

15. A method of providing certified payments, comprising:
receiving, with a processor, payment instructions from a payer computing device, wherein the payment instructions include a payment account, a payment amount, an alias associated with a payee, and a payment certification request;
determining, with a processor, that the payee is a registered payee based on the alias;
determining, with a processor, that the payment account has funds sufficient to cover the payment amount;
placing, with a processor, a hold on funds in the payment account sufficient to cover the payment amount;
communicating, with a processor, a certified payment notification to the payee based up determining that the payment account has funds sufficient to cover the payment amount and determining that the payee is a registered payee based on the alias;
receiving, with a processor, a payment cancelation request from the payer;
determining, with a processor, whether a payment certification code has been communicated to the payer; and
if a payment certification code has not been communicated to the payer, approving, with a processor, the payment cancelation request.

16. The method according to claim 15, comprising, based upon approving the payment cancelation request, removing the hold on the funds sufficient to cover the payment amount, communicating a payment cancelation notification to the payer, and communicating a payment cancelation notification to the payee.

17. The method according to claim 15, wherein:
placing a hold on funds in the payment account sufficient to cover the payment amount comprising transferring funds in the payment account sufficient to cover the payment amount to a financial institution financial institution general ledger; and
removing the hold on the funds sufficient to cover the payment amount comprising transferring the funds in the general ledger sufficient to cover the payment amount to the payment account.

18. The method according to claim 15, comprising:
before receiving the payment cancelation request from the payer, communicating a payment certification code to the payer based upon determining that the payment account has funds sufficient to cover the payment amount;
determining that the payment certification code has been communicated to the payer;
based upon determining that the payment certification code has been communicated to the payer, denying the payment cancelation request and communicate a cancelation request denial notification to the first user.

19. The method according to claim 15, wherein communicating a payment certification code to the payer comprises:
receiving a payment certification code request from the payer; and
thereafter, communicating the payment certification code to the payer based upon determining that the payment account has funds sufficient to cover the payment amount.

20. The method according to claim 15, comprising:
receiving the payment certification code from a payee computing device; and
transferring the funds sufficient to cover the payment to an account associated with the payee based upon receiving the payment certification code from the payee computing device.

21. The method according to claim 15, wherein:
placing a hold on funds in the payment account sufficient to cover the payment amount comprising transferring funds in the payment account sufficient to cover the payment amount to a financial institution general ledger; and
transferring the funds sufficient to cover the payment to an account associated with the payee comprises transferring the funds sufficient to cover the payment from the financial institution general ledger to an account associated with the payee.
